(19) United States
(12) Patent Application Publication
(10) Pub. No.: US 2005/0030309 A1
(43) Pub. Date: Feb. 10, 2005

(54) Information display

(76) Inventors: David Gettman, London (GB); David Brownlee, London (GB); Nicole Morris, Monaco (MC)

Correspondence Address: HICKMAN PALERMO TRUONG & BECKER, LLP, 1600 WILLOW STREET, SAN JOSE, CA, 95125, US

(21) Appl. No.: 10/864,660

(22) Filed: Jun. 8, 2004

Related U.S. Application Data
(63) Continuation-in-part of application No. 10/727,799, filed on Dec. 3, 2003.

(30) Foreign Application Priority Data
Jul. 25, 2003 (GB) 0317493.5

(51) Int. Cl. G06T 15/00

(52) U.S. Cl. 345/419

(57) ABSTRACT

A computer system comprises a content provider computer that is communicatively coupled to a network and that is associated with a network location identifier; one or more city servers that are communicatively coupled to a network, wherein each of the city servers hosts a data definition of a virtual three-dimensional space that comprises a plurality of virtual display windows, wherein each of the virtual display windows is allocated a specific position in the space and is associated with the network location identifier; one or more client computers that are communicatively coupled to the network, wherein each of the client computers hosts a three-dimensional virtual space browser that is configured for receiving network content from the content provider based on the network location identifier and for rendering and displaying the virtual display windows within the virtual three-dimensional space.

### CROSS-REFERENCE TO RELATED APPLICATIONS; PRIORITY CLAIM

This application claims the benefit under 35 U.S.C. §119 of prior United Kingdom application 0317493.5, filed Jul. 25, 2003, entitled “Information Display,” the entire contents of which is hereby incorporated by reference as if fully set forth herein. This application claims priority under 35 U.S.C. §120 as a Continuation-in-part of prior application Ser. No. 10/727,799, filed Dec. 3, 2003, the entire contents of which is hereby incorporated by reference as if fully set forth herein.

### COPYRIGHT NOTICE

A portion of the disclosure of this patent document contains material which is subject to copyright protection. The copyright owner has no objection to the facsimile reproduction of the patent disclosure, as it appears in the Patent & Trademark Office patent file or records, but otherwise reserves all copyright rights whatsoever. Copyright©2004 Purple Interactive Ltd.

### FIELD OF THE INVENTION

The present invention generally relates to data processing. The invention relates more specifically to information display.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Modern display or presentation devices typically include computer apparatus such as networked, desktop, laptop, handheld or tablet personal computers (PCs), personal digital assistants (PDAs), interactive television terminals, gaming apparatus and cell phones. Each item of apparatus usually has a single display, and this may be in the form of a traditional computer, television or cell phone display screen or may take the form of projection equipment, virtual reality goggles, projection spectacles, holographic projections, electronic paper or cerebral implants.

There is a desire amongst viewers accessing a large volume of material content to be able to browse and navigate the full set of content in order to find a subset or single unit of content which is relevant or interesting to the viewer. Currently such browsing and navigation is typically conducted by means of descriptive text typed into search engine software and thereby matched to text contained in the material content itself or to text which a content provider has used to label the content. Browsing and navigation is also sometimes aided by third-party content categorisers who provide directories and sub-directories of content labels and descriptions.

However, these techniques for browsing and navigating large volumes of material content for display inevitably rely upon the individual viewer's skills in language and logic, as well as that of the content providers. With directory searching, the viewer must guess and replicate the logic followed by the third-party content categorizers, who must categorize and describe material content accurately and in a way which will readily be found by the intended viewers. With text entry searching, viewers need a good verbal memory to think of appropriate search terms, an extensive vocabulary, and skills in using Boolean logic in order to enter the most effective text, and content providers must accurately guess which keywords will be entered by viewers searching for their material content.

### BRIEF DESCRIPTION OF THE DRAWINGS

For a better understanding of the present invention and to show how the same may be carried into effect, reference will now be made to the accompanying drawings in which:

FIG. 1 is a diagram of a screen display generated by one embodiment of an information display method;

FIG. 2 is a flow diagram illustrating the sequence of steps of an information display method;

FIG. 3 is a diagram of a screen display generated by one embodiment of an information display method;

FIG. 4 is a diagram of a screen display generated by one embodiment of an information display method;

FIG. 5A is a block diagram of a city server system;

FIG. 5B is a block diagram illustrating further architectural elements of the system of FIG. 5A;

FIG. 6A is a flow diagram of a process of establishing a city server;

FIG. 6B is a flow diagram of a process of browsing a virtual city;

FIG. 6C is a diagram of a virtual city screen display generated by one embodiment of an information display method;

FIG. 6D is a diagram of a virtual city grid screen display generated by one embodiment of an information display method;

FIG. 7 is a flow diagram of a process of renewing a transaction associated with a display window in a virtual city;

FIG. 8 is a flow diagram of a process of auctioning a right to display information in a display window of a virtual city;

FIG. 9 is a flow diagram of a process of transferring a right to display information in a display window of a virtual city;

FIG. 10 is a block diagram of an example virtual space browsing system in which an embodiment may be used; and

FIG. 11 is a block diagram that illustrates a computer system upon which an embodiment of the invention may be implemented.

### DETAILED DESCRIPTION OF THE PREFERRED EMBODIMENT

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Example Implementation
   2.1 Overview of User Interface and Browsing Methods
   2.2 Structural Overview; City Server Architecture
   2.3 Establishing City Content; Browsing City Content
   2.4 Renewals, Auctions and Transfers of Virtual Property
   2.5 Three-Dimensional Virtual Space Browser Architecture
3.0 Hardware Overview
   1.0 General Overview

The invention is a method of organizing and displaying a large volume of material content in a manner that can be easily browsed and accurately navigated by a viewer without relying upon the viewer's, nor the content providers', skills in language or logic.

The material content may be information in any form, for example: data, numbers, text, still images such as photographs and graphics, moving images, virtual control panels and sound. It may be retrieved from a local computer disk or removable storage media or any form of network such as a local area network, a wireless network, a cell phone network, a wide area network, an internet, extranet or the Internet. The invention may, for example, be used for displaying material content on a computer screen and navigating through the type of material content typically found on the Internet.

According to one aspect of the present invention there is provided a method for organizing and presenting material content on a display to a viewer, the method comprising: mapping a plurality of display windows within a virtual three-dimensional space so that each display window is allocated a specific and predetermined position in the space, rendering each display window in three-dimensional perspective according to its position and angle relative to a viewer's virtual position in the virtual space, cross-referencing the position of each display window to a storage location of the material content that is designated to be rendered in that particular display window at a particular time based on at least one predetermined condition, allocating at least part of the three-dimensional virtual space to display windows whose content is not chosen or determined by the viewer, selecting, retrieving and preparing material content for possible subsequent display, according to a predetermined algorithm, selecting and rendering prepared material content within its cross-referenced display window, according to a predetermined algorithm, and providing a means of virtual navigation that changes the viewer's position in the space in such a manner as to simulate movement through a plurality of predefined channels in the virtual space.

A browser adapted to perform this method is also provided, as is apparatus programmed to operate the browser.

According to a second aspect of the present invention there is provided apparatus for organizing and presenting material content on a display to a viewer, the apparatus comprising: a display, means for mapping a plurality of display windows within a three-dimensional virtual space so that each display window is allocated a specific and predetermined position, means for rendering each display in three-dimensional perspective according to its position and angle relative to the viewer's position in the virtual space, means for cross referencing the position of each display window to the network address or storage location of the material content that is designated to be rendered in that particular display window at a particular time based on at least one predetermined condition, means for selecting, retrieving and preparing material content for possible subsequent display according to a predetermined algorithm, means for selecting and rendering prepared material content within its cross-referenced display window according to a predetermined algorithm, and means for navigation controlled by the viewer that changes the viewer's position in such a manner as to simulate movement through a plurality of predefined channels in the virtual space.

According to a third aspect of the present invention there is provided a virtual space manager comprising a content configurator that includes the interface for the creation, maintenance and updating of the configuration which incorporates a plurality of cross references of content material to render in display windows.

According to a fourth aspect of the invention the method of the first aspect may be adapted as a business method for example when used to supply in exchange for financial payment the right to specify the network address or storage location of material content that is to be rendered in a particular display window at a specified location at a particular time, and optionally enabling and recording the transfer of rights in exchange for financial payment, and/or providing an auction system inviting financial bids to the current holder of rights and awarding the rights to the highest bidder provided predetermined conditions are met, and/or providing advertising opportunities in the three-dimensional virtual space in exchange for financial payments.

In addition, a viewer's navigation into a restricted area of the three-dimensional virtual space is allowed for a particular period of time in exchange for financial payment. Added value services may also be provided in exchange for financial payments, e.g. avatar companions, guides to navigation, the ability to navigate simultaneously and interactively with one or more other actual viewers, e-commerce support, and financial services including foreign exchange, credit and budget planning.

The method of the invention may be used to enable any one or more of Internet browsing, virtual stores, virtual supermarkets, virtual shopping malls, virtual retail catalogues, knowledge management, virtual exhibitions, medical records management, virtual hospital patient management, virtual galleries, virtual museums, entertainment choices, tourist guides, TV guides, news digests, travel/hospitality option guides, virtual trade fairs and photo libraries.

According to a fifth aspect of the invention there is provided a browser for retrieving pages of material content over a computer network, comprising means for selecting material content for display according to a predetermined algorithm, means for cross-referencing the position of each display window to a storage location of selected material content based on at least one predetermined condition, means for allocating at least part of the three-dimensional virtual space to display windows whose content is not chosen or determined by the viewer, and means for retrieving and rendering selected material content within its cross-referenced display window according to a predetermined algorithm.

According to a sixth aspect of the invention there is provided a business method comprising offering to download a browser (according to the fifth aspect) to a plurality of potential viewers and offering the display windows in the virtual space for rent to potential rights owners in the form of business and commercial enterprises.

The present invention has advantages because it does not rely upon language and logic in browsing and navigating large volumes of content. Instead of relying upon language and logic, the invention makes it possible to indicate the relevance of content to a viewer by applying a rule of spatial proximity. Specifically, if content A is relevant to the viewer, and content B is similarly relevant, then A and B can be positioned near to one another, so that the viewer of content A is likely also to see content B with a minimum of navigation.

In order to apply the rule of spatial proximity to material content in displays, the present invention may utilize and uniquely combine three methods:
(1) The creation of a three-dimensional virtual space containing many display windows in fixed, specified positions,
(2) The realistic topographical navigation of this world by viewers, which prevents them jumping instantly from one display window to any other, but instead forces them to travel smoothly along surface channels that expose the viewer to other display windows along the way, and
(3) The operation of a self-organising allocation process in which content providers compete for the most beneficial display window positions for their content.

Corresponding to these three methods are three forms of prior art which make clear the novelty of the present invention:

(1) The creation of a virtual three-dimensional world of display in fixed, specified positions.

A browser that also configures display windows in three dimensions is described in International Patent Application Publication Number WO01/82295. This describes a browser that arranges HTML pages on the back, top, bottom, left and right inside faces of a cube, with the viewer positioned just inside the nearest (sixth) face. Each of the five navigable inside faces can open into a further cube. The aim is to enable the viewer simultaneously to see several pages selected by the viewer. This could be especially useful where the content on the five pages is being compared or contrasted.

The present invention differs from this disclosure in several respects: in particular because the display windows in the present invention have fixed, specified positions in the space rather than being subject to manipulation by the viewer, and the content on display is predetermined by cross-references rather than by the viewer.

(2) The realistic topographical navigation forcing the viewer to travel smoothly along the surface and thus be exposed to display windows on the way.

Another method for searching and presenting information in a geography-based configuration which also provides realistic navigation is described in U.S. Patent Application Publication Number US 2002/0059207 A1. This method converts multiple aerial photos of an actual city into a three-dimensional stereoscopic aerial view, and allows the viewer to move across this view, simulating a ‘sight-seeing flight’, and to request information pertaining to his or her location. This is done by linking the latitude and longitude of the viewer's position with ‘landmark databases’ compiled using conventional Internet searches based on keywords or other verbal expressions. Multiple viewers can interact and be tracked.

The present invention differs from this disclosure in several respects: the content being presented in the present invention is organized by predetermined cross references rather than by reference to their physical property locations, and material content is directly displayed in windows forming part of the landscape being viewed rather than indirectly displayed as separate page data.

(3) A self-organizing allocation process in which content providers compete for the most beneficial display window positions for their content.

Another method comprising a self-organizing allocation process for the display of large volumes of material content is described in U.S. Pat. No. 6,308,202. This method invites each primary content provider on the Internet to select one or more of thousands of verbal categories to describe their content and then allows other secondary content providers, for example advertisers, to supply relevant additional information to anyone viewing the primary categorized content. By allowing both primary and secondary content providers to determine the categories they believe are most relevant to their content, the allocation of secondary information to interested viewers is optimized. The present invention differs from this disclosure in several respects, particularly since material content in the present invention is displayed in predetermined cross-referenced display windows. In embodiments of the present invention: content providers select relative positions in a virtual space to describe their content rather than use verbal categories; the exposure of viewers to relevant secondary content is achieved by virtue of the required realistic method of navigation, rather than it being imposed as a separate unrequested display of content; and due to the competitive nature of the self-organising process, the ‘description’ (i.e. the position in the virtual space) assigned to any particular material content reflects not just its meaning but also the value ascribed to that content by its provider.

The present invention benefits both content providers and content viewers:

Content providers using embodiments of the invention have control over where and how their content is seen in the context of all content, rather than granting that control to third-party content categorizers or the rule-makers of search engine software. Content providers using embodiments of the invention also need not rely on verbal descriptions (e.g. domain names, meta-text, directory entries, or descriptive advertisements) to attract interested viewers, but instead can attract relevant viewers to their content by means of its contextual position and the quality of its visual treatment. Because the self-organizing is competitive, the prominence of displayed content is commensurate with the importance of the communication to the content provider.

Viewers using embodiments of the invention can rely upon the naturalistic, non-verbal experience of perceiving the relatedness of two entities by their spatial proximity, rather than relying upon terms or names they happen to recall, or entering topics into search engines in accordance with Boolean logic. Viewers can also more rapidly decide the relevance of content by relying on quick visual impressions rather than reading lists of arbitrary text excerpts. Lastly, viewers using embodiments of the invention can experience the serendipity of discovering new, hitherto-unknown content, or content that its provider considers to be of interest to them, rather than being limited to content that the viewer has had to search for and therefore must already know about.

The present invention enables the designation and fixing of the association of material content with other material content in a three-dimensional space containing display windows that are each rendered in three-dimensional perspective. In one embodiment of the present invention, the configuration of these display windows, each containing material content, is analogous to shop windows on a city street.

To populate this system with content, content providers may be invited to specify their material content to appear in a particular window which by virtual spatial proximity associates their material content with what they consider to be related material content in surrounding and nearby display windows. In this way, associated content, presented in display windows, will self-organize into virtual neighborhoods of related content that the user can browse as one would the shop windows along streets of a city. Having located a display window with content of interest to the user, the user may without verbal or logical discernment easily find other content in nearby windows that its providers have decided would also be of interest to the user.

2.0 Example Implementation

2.1 Overview of User Interface and Browsing Methods

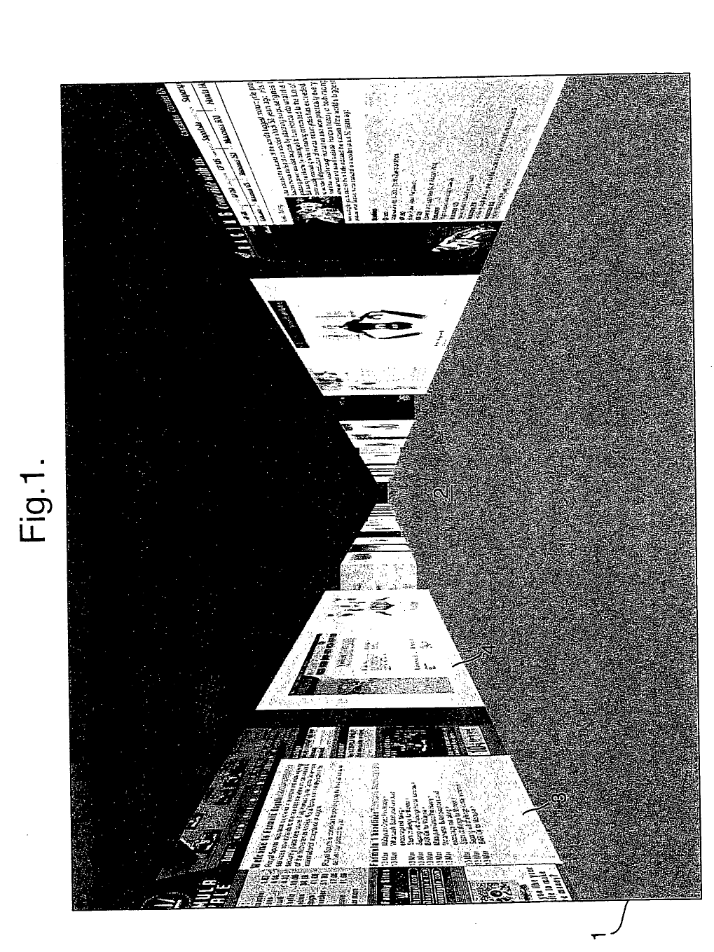

In FIG. 1 a display 1, which may be a screen of a computer, is shown, on which is depicted an image of a virtual street 2 seen in three-dimensional perspective from the middle of the street 2. Buildings 3 are located on each side of the street 2, and each has one or more virtual display windows 4 facing the street 2. The buildings and the street decrease in size, appearing to recede, as they get further from the nominal position of the viewer. The angle of recession is chosen so that the perspective appears natural but so that content displayed in the display windows on the sides of the buildings is clear. The relative width w and height h of each display window 4 is chosen to match the content to be displayed, but in the embodiment using Internet pages is chosen to match that of the normal visible HTML page area in a traditional Internet browser, i.e., the standard screen size minus the space used by scrollbars and tool bars. This gives the viewer the impression that he is standing in a street having shops with shop windows on each side. Each virtual display window 4 shows a page of content retrieved from an Internet HTML page. These may be the home pages of commercial concerns or pages specially generated for display in this format.

The actual number of visible display windows will be chosen so that the overall view looks realistic and so that a reasonable number of the windows are clearly visible. The number can be variable in dependence upon the performance of the computer or adjustable by the viewer to enhance performance or to enhance the detail of rendering of content in the windows. For example, it may be appropriate to display two blocks of the street at a time and three windows on each side in each block but to replace the more distant windows with a low-resolution rendering or even a small icon.

The viewer's viewpoint can be moved up or down the street 2 and as it is moved, the display changes to bring other windows 4 into view and to change the relative sizes of the displayed buildings 3. The changes must be accomplished realistically and smoothly. The viewer can also turn left or right to face a particular window to inspect more carefully the content displayed there. If the content comprises Internet HTML pages then at that point the HTML page displayed in that window can be opened by the viewer to fill a separate Internet browser of more traditional two-dimensional appearance. Optionally the viewer can then interact with the chosen HTML page in the traditional manner, for example by using mouse clicks on a part of it to access another page of information or to make a choice such as initiating a purchase from a shopping system represented on the page.

The street 2 is part of a larger virtual space such as an urban landscape in the form of a town or city set out in a grid-like city block layout although the layout of the landscape need not necessarily be in the form of a uniform perpendicular grid: “curved roads” and “traffic circles” may be incorporated and narrow “paths” may lead off from wider “streets”. “Hilly” surfaces and “ravines” or other geographic representations may be included. The virtual space may be limited or infinite or limited in some directions and may be on more than one plane. The display windows will typically have straight edges as shown in FIG. 1, but may be made more eye-catching with decorated frames.

The viewer can navigate through the landscape by making appropriate key strokes on the keyboard, by mouse movements or by using a joystick, track pad, trackball, touch screen, remote control or virtual reality gloves or a steering wheel, in manners known to persons skilled in the art. Several navigation speeds are envisaged which would generally be under the control of the viewer. For example the viewer may “move” at walking speed through the “streets” or may choose to move at the equivalent speed of a taxi, within the same plane as the display windows. The viewer may also opt to move at an even higher speed in a different plane to the display windows, for example in a manner analogous to a subway system or a helicopter. However it is intended that limits would be applied to the viewer's “movement” through the landscape to avoid the possibility of the viewer instantly jumping to a specified display window location in the landscape because such a movement would undermine the organizational principle that enables the viewer to find relevant content: namely, content providers locating their content in virtual spatial proximity to associated content.

Each display window 4 may be sold or rented to a commercial concern or other organization and has a fixed position in the landscape, in a similar manner to the fixed addresses of shops or businesses in a real town or city. In this way the viewer becomes familiar with the positions of his or her favored windows and can easily search and select relevant “neighborhoods” of material content.

The display is organized by a controlling browser program operating locally, e.g. on the viewer's computer terminal. The browser program controls the display of the virtual landscape, navigation of the viewer's position through the landscape, and the retrieval, preparation and rendering of content displayed in each window. In an internal or external cross-referencing file, the URL of the Internet HTML page of each relevant commercial concern owning or renting a display window is associated in the program with the specific display window the concern has reserved. Periodically, bitmap screenshots of a set of HTML pages relevant to the windows in the local vicinity of the viewer in the landscape (e.g. those associated with all of the display windows in the blocks and streets adjacent to or around the corner from the viewer) are cached in local memory. In one implementation, this uses an adapted HTML page-rendering engine which can import live HTML pages in a way in which their contents are reproduced dynamically. Thus a set of live HTML pages is continuously saved in memory at the viewer' terminal. The number of HTML pages thus saved will depend upon the available memory and the processing power of the terminal as well as the number of windows displayed on the screen at any one time, but might typically be 9.

When a window first becomes visible in the viewer's screen, the corresponding cached HTML page is copied by the program from the internal memory and rendered in the window. The page is not rendered dynamically until the viewer turns toward it (and “clicks” on it or remains in that position for a set period of time), at which stage the dynamically cached page may be displayed in a two dimensional, conventional-style browser display box. Totally live dynamic rendering of all visible HTML pages in-situ on a street would be possible with sufficient processing power.

As the viewer “moves” along the street, distant windows come into view and close-by ones pass out of sight “behind” the viewer. Thus the program carefully selects the set of HTML pages to cache and store in memory to ensure a smooth and fast appearance of rendered display windows as the viewer “moves”, by ensuring that HTML pages corresponding to approaching windows are downloaded into memory in time. A certain amount of predictive programming must be built-in to anticipate the next likely “movements” of the viewer, for example on the basis of previous navigation patterns.

It is envisaged that facilities will be provided on an administration Internet site to allow the registration of the rights of content providers to own or rent particular display windows, to manage transactions (e.g. taxes and fees), and to allow a display window owner or tenant to upload directly their network address or storage location and maintain their display window. The rights holder may test the appearance of their display window and view statistics or contour maps indicating the number and frequency of visits to their window and/or simulations of corresponding virtual “property values”.

There may be a number of different neighborhoods or districts in the virtual city, each with its own distinctive layout and look and feel, just as in a real city. For example, there may be an area in which HTML pages of interest to young people predominate, or an area which specializes in public sector content. In one embodiment, a particular area of the “city” is designated as the viewer's “hometown” area and is populated, for example, with the viewer's own favorites or bookmarked HTML pages, or with pages found from a conventional search.

Different sections of the virtual city could be designated “gated” areas which would be accessible only to users with a special subscriber pass: given either by virtue of payment made by the viewer in advance or for example on condition that the viewer has proven that they have a sufficient credit rating for financial transactions within the “gated” area or are a member of a club.

The layout of the “city” is detailed in a standard format XML file in the form of plot data, which in the example given is for a three window by three-window city block grid layout, although other layouts are possible. The XML file may be contained in the control program loaded on the viewer's computer (the client) or may be retrievable from a remote server via a standard HTTP connection in which case there will be security to protect the integrity of the file.

Any of the pages may incorporate sounds but it is most practical to suppress sounds from pages other than those closest to the viewer. For example sound on the pages in the windows directly to the left and the right of the viewer's nominal position could each be set at a volume of 50% in the left and the right stereo channels respectively. If a viewer turns to face a page then that page plays at 100% volume. When a page is more than half way out of view the volume is lowered to 25%, and the volume of the next page is increased to 25%.

As already mentioned, navigation may be performed by keyboard strokes, mouse movements or a joystick. Traditionally the arrow keys on a keyboard are used for movement e.g. in one implementation when the “up” key is depressed the viewpoint moves forward at a predetermined pace, and releasing the “up” key stops the viewpoint at the next full window, i.e. at the point when the nearest vertical edges of the windows abut the left and right vertical edges of the display area. Pressing the “down” key moves the viewer back (while facing forward) and the “left” key makes the viewer turn to face the window to the left. Likewise the “right” key is used for a right turn. At intersections of “streets” the “right” key turns the user right onto the perpendicular “street” and the “left” key turns the user left onto that “street”.

More advanced forms of navigation can be incorporated, for example using a variety of keys, mouse-movement controls and right-click shortcuts and these are well known, particularly in the field of video game programming and usage.

In one embodiment there is an experience simulating transport by underground train built into the virtual city. Several display windows throughout the virtual city are rendered to appear as underground train stations and the viewer can “enter” a station by turning to face the relevant display window, using an appropriate navigation technique. A diagrammatic map of all “underground train stations” is then displayed to the viewer “in” the station and he can then select a destination station by “clicking” on the appropriate part of the map to travel to a different part of the “city”. A typical long distance “journey” might take 10 to 15 seconds and during this simulated journey the control program activates the display to the viewer of a series of advertisements which would typically be paid for by the owners of the display windows near the destination station. This would be analogous to advertising hoardings at real underground train stations and on real underground trains. At the destination station in a different part of the virtual town, the viewer would “exit” the station through another window rendered as a train station and emerge into a street rendered with the HTML pages chosen by owners of display windows in that part of the “city”.

The virtual city is typically entered only via designated gateways or portals to facilitate the viewer's familiarity with and navigation through the landscape. There is a single major “default” gateway, and a series of secondary gateways which can be selected from a map or menu or randomly offered to a viewer. The underground train stations would comprise some of the secondary gateways. Gateways could be depicted in striking or memorable designs to aid navigation.

The selection of which gateway is used to enter the virtual city can be made by a viewer each time the program is launched but if no selection is made then the entry gateway will default to the main gateway.

A bird's-eye view topological map of the whole virtual city or the neighborhood or district in which the viewer is located at any one time is displayed, either adjacent to or behind the main viewing window. The path taken by the viewer may be highlighted on this map, either for the current session alone or for the current and at least one previous session. A zoom option would also be provided, leading to the display of larger, more detailed maps. Such a map may have certain “landmark” display windows marked, these possibly being determined by the owners having paid a fee to appear on the large scale maps. When navigating the main window in the usual way, the viewer may also be allowed to rise up above the virtual space to get an overview of his current location and environs in the virtual city.

Locations visited by a viewer could be “bookmarked” or “searched for” in the traditional manner. However, the viewer is unable to jump directly to a bookmarked or search result location but must instead travel along the streets to reach it, in one embodiment guided by the most efficient route being highlighted on the map or automatically led there through the streets. In this way the viewer will find his or her way around the virtual landscape and will learn the positions of particular Internet sites. In addition, this inability to jump means that the viewer must pass many display windows and the owners or tenants of those windows will have the advantage of more viewers seeing their content.

An avatar may represent the viewer and/or a shopping companion; for example an amusing pet or an attractive imaginary friend may be depicted on the screen. Such a companion could move just in front of the notional position of the viewer and might point out new window displays, changes, promotions, sales or windows which are considered likely to interest the viewer on the basis of past navigational behavior. Several viewers can “window-shop” together if they are logged on simultaneously. In this embodiment there is a system for assigning navigation control to one of the group. A means of communicating between the viewers, such as a text or voice chat line for conversation, or an on-screen messaging facility, may also be incorporated and the technology for such features is well known.

Viewers could also be given a visual representation of the number of other viewers in their current vicinity: for example a translucent silhouette of one person representing one thousand, or one million, other viewers. This would serve to indicate the relative popularity of neighborhoods, streets and windows and would also assist window owners or tenants to determine the effect of a change in their display or to assess the advantage of paying more “rent” or a higher “purchase price” for a display window in a busier, more popular part of the city.

The virtual buildings could have several stories, allowing different levels of windows, analogous to different stories of a shopping mall in real life. To the elevations of these virtual buildings where a display is not practicable could be affixed advertisements or virtual signs relating to the display windows immediately below them, providing a means of attracting viewers to navigate their way towards the advertiser's display window.

Streets and neighborhoods may be assigned names to assist in navigation for the viewer and to facilitate the sale or rental of prime locations. Landmarks may also be incorporated to assist the viewer in navigation. For example statues, architecturally interesting buildings such as distinctively decorated or designed buildings, fountains and parks may be used to identify specific areas of the landscape.

Adjacent windows could be merged to create larger windows and several different virtual cities could be created and linked by a rapid transport system in a similar way to the underground railway described above.

In a more advanced embodiment viewers will pass “through” the windows and the screen will then display a virtual rendering of the “inside” of an associated establishment. Thus, for example, the display window of a supermarket can be a gateway into the virtual supermarket itself and on “entering” the window the viewer would see the virtual “streets” become virtual aisles of the supermarket. Instead of displaying HTML pages of internet sites in the windows lining the aisles, HTML pages of sets of product images are displayed and a “click” on an individual product initiates a dialog box to display product details as supplied by the retailer: for example, ingredients or other details or the sizes, prices or colors available. A transparent interface with the retailer's own existing shopping cart may be provided in the control program.

The virtual town may be replaced by other virtual three-dimensional spaces in addition to the above example of a virtual department store, supermarket or retail catalogue establishment. A virtual shopping mall would be populated with display windows representing a variety of shop fronts or a virtual museum with exhibition cases or exhibits. Other applications are envisaged such as virtual tours of representations of actual cities, virtual trade fairs, virtual photo libraries, entertainment choices (e.g. videogame selection), TV program selection, or business or academic libraries. It would also be possible to use this method to access technical data or medical records.

Viewers are requested to register their details and their navigation behavior could be collected for sale to display window owners or tenants.

Display window owners or tenants can utilize the top portion of the window for a display sign or banner of their name label or brand for the convenience of the viewers.

Many further advertising “signs” and “hoardings” could be incorporated such as to resemble hanging signs and sandwich signs outside a shop window, as well as display advertisements on the floor of the street outside a window or directing viewers to a particular window.

From a technical point of view, the browser software preferably comprises two sections. A first section, running at high priority, controls the display of the virtual three-dimensional environment (e.g., the virtual city) and the navigation of the viewer around that environment. A second section, running at lower priority, updates the content for display windows.

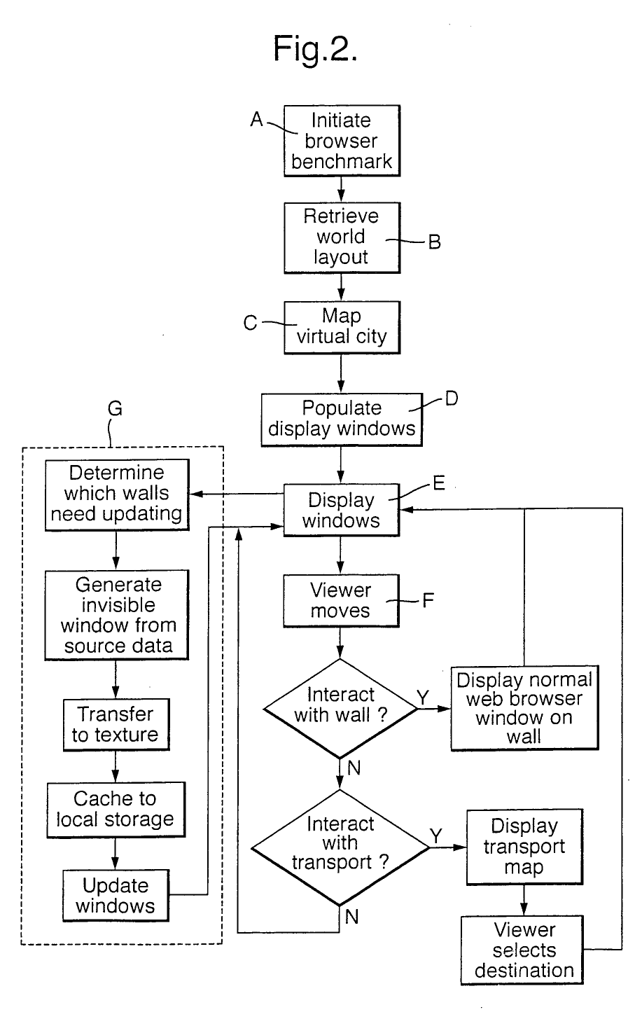

Steps taken by one embodiment of such a browser will now be described with reference to the flow diagram of FIG. 2 for operation of the software when installed on a network with the viewer using a client computer terminal connected via HTTP to a remote server computer.

In step A, the browser is first initiated and may run several brief benchmarking tests to determine the optimal settings that will ensure a smooth and responsive display. This benchmarking is determined by assessing the resources available, i.e. the computing speed, graphics card, and memory capabilities of the client computer.

In step B, the browser then retrieves the layout of the virtual space or world to be displayed (e.g. the virtual city) from the remote server computer or a file saved locally.

In step C, the retrieved layout is used by the software to map the virtual city for internal use by the viewer's computer (the client) and the browser generates a simulated three-dimensional environment depicting display windows closest to the nominal position of the viewer, for example at the default gateway. The perspective is adjusted to ensure that items closer to the nominal position of the viewer are larger. Each display window 4 has a relative width and height to match (or have similar proportions to) that of the visible HTML page area in a traditional Internet browser. This would typically be the standard screen size minus the space used by scroll bars and toolbars. The size of the display windows, resolution of the graphical textures in the display windows and number of rendering threads depends upon the benchmark conditions established in the initialization process. For illustration purposes, blocks of three display windows length and width are considered as shown in FIG. 1, but any configuration would be possible. The browser then assigns addresses, typically URL addresses for HTML pages, to each window according to the retrieved layout.

In step D, cached HTML pages stored as textures in the client computer memory are used to populate the display windows in memory.

In step E, the browser displays the three-dimensional environment on the display.

In step F, the viewer can move around in the area of the street or corridor 2 between the display windows 4 and the viewer can interact with individual display windows 4. The browser also enables the viewer to interact with an underground railway station and in that case displays a map of available underground railway destinations from which the viewer can make a selection.

In step G, the browser has several threads running simultaneously, each processing material content and updating the texture used for the respective display windows. These threads comprise the following procedures:
an algorithm running in a control thread determines which display windows require updating based on a number of factors including the locality of the user and the age of displayed content,
the browser may initiate a connection to download the source data,
source data is used to generate an invisible window,
the contents of the invisible window are transferred into a texture,
the textures are periodically cached to a local storage medium to permit a rapid repopulation of the environment when the browser is next run,
display windows closest to the viewer which contain moving images or sound may be kept active so that changes are continually reflected on the display window in real time.

Log files may be used for recording the frequency with which viewers pass-by, draw close to, or interact with any display window, and thus data can potentially be provided in summary to commercial owners and tenants either free or for consideration. Such data can be displayed as a contour map indicating traffic densities across the virtual space.

The technical approach described here involves the textures used for the display windows being rendered by the client program. In an alternative technical approach, a centralized cluster of servers could create the textures, and these could be downloaded by the client program.

It will be seen that the display and navigation methods of the present invention can be used in business methods to raise revenues.

For example, the virtual space may be used in an analogous way to any property space and new properties can be sold or leased, ground rents and service charges imposed, property tax applied to transfers of window rights, an administration charge made for sales, and procedures adapted to re-possess voided leases. In addition, advertising space, markings and signage can be leased, virtual moving advertising carriers included (e.g. vans or floating items), avatar shopping guides provided, and coupons could be distributed to viewers passing a particular window. Advertising agencies can act as virtual property agents for clients and virtual outdoor media owners can act as display window aggregators. Multiple interlinked three-dimensional “worlds,” each containing one or more “cities,” can be represented, and technology companies could each host separate such “worlds.”

In addition, road tolls, gateway tolls, admission fees and transport charges could be built into any model.

By analogy with e-commerce business methods, a sales tax could be imposed on viewers transacting with content providers. An auction system could be used to enable display window rights owners to buy or sell their rights to others. The presentation, display and navigation method has many possible applications. Apart from the HTML browsing and virtual shopping embodiments described in detail above, virtual entertainment guides, tourist guides, trade fairs and travel/hospitality guides could be created. The method also finds application in displaying the contents of libraries, photo libraries, scientific data, and medical records and it could play a role in virtual government.

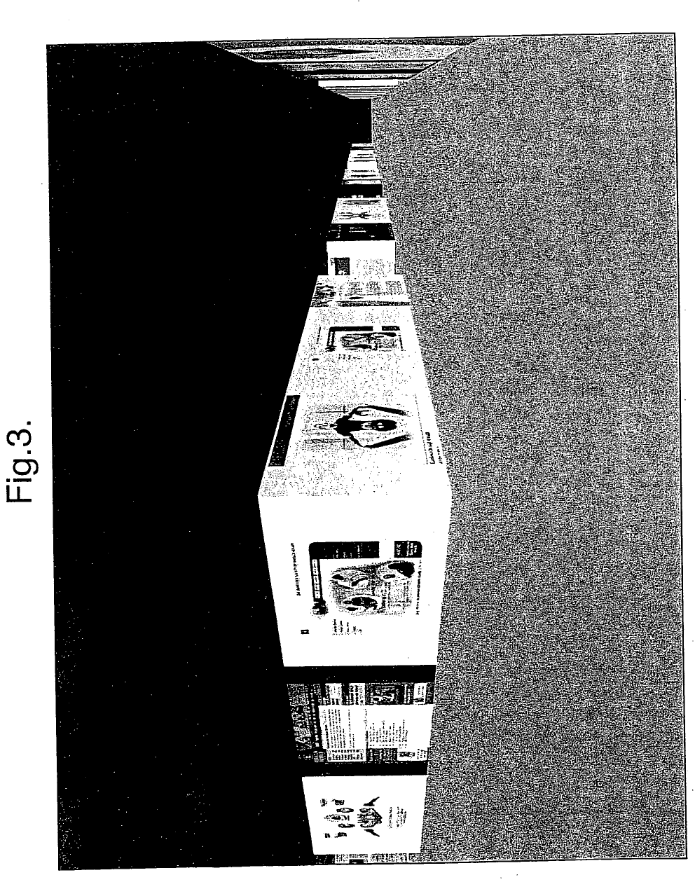

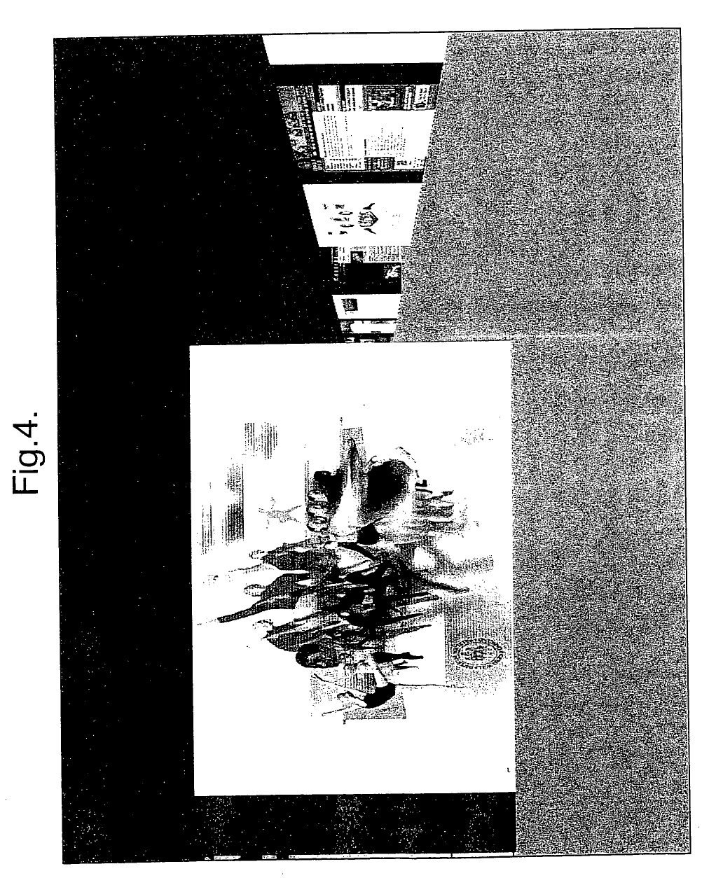

FIG. 3 and FIG. 4 show alternative views of the three-dimensional space. For example, in FIG. 3 the viewer is at a “corner” of a “street” with a “side street” running off to the left. In FIG. 4 the viewer is facing a display window and could potentially interact with the window in the manner of a conventional two-dimensional browser.

In another embodiment, a virtual city comprises one or more virtual multi-storey buildings. Each storey of the multi-storey buildings comprises one or more virtual display windows. Such an embodiment provides a larger number of available virtual display windows than an embodiment in which all virtual display windows form part of one-storey buildings.

2.2 Structural Overview; City Server Architecture

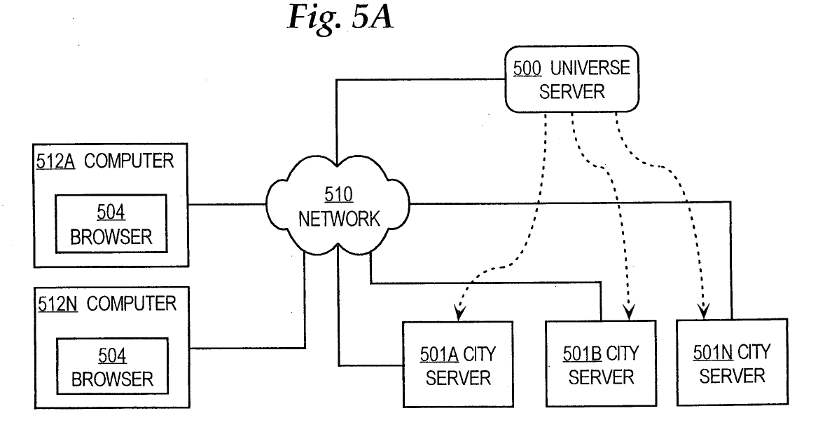

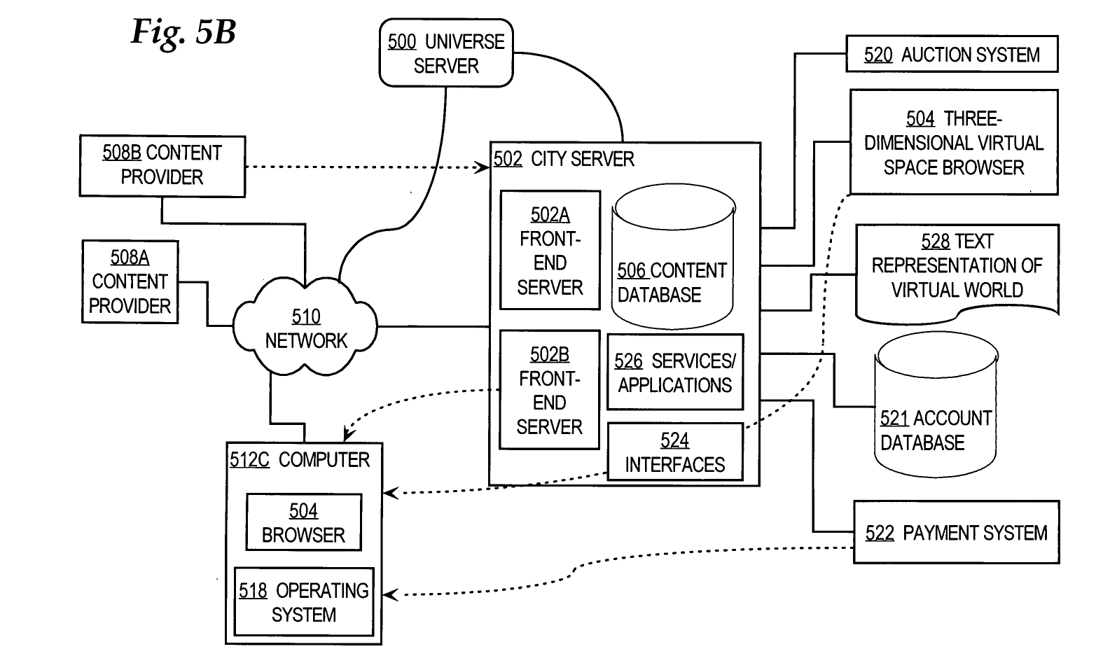

FIG. 5A is a block diagram of a city server system that may be used to implement an embodiment. One or more computers 512A, 512N hosting respective copies of a browser 504 are communicatively coupled to a network 510. One or more city servers 501A, 501B, 501N are communicatively coupled to network 510. A universe server 500 is also coupled to network 510 and supervises or manages the city servers 501A, 501B, 501N. For purposes of illustrating a simple example, two computers 512A, 512N and three city servers 501A, 501B, 501N are shown; however, an implementation may include any number of such elements.

Computers 512A, 512N may comprise any type of personal computer, workstation, or other end user station that can execute a browser. Browser 504 comprises a three-dimensional virtual space browser of the type described further herein. Network 510 comprises one or more local area networks, wide area networks, internetworks, or a combination thereof consisting of any number of direct or indirect links of any form, including wired metal or optical links, or wireless radio-frequency links, etc.

Each city server 501A, 501B, 501N comprises a computer system that can host and deliver applications that enroll tenants for display of content in virtual windows of a virtual city, and that can host and deliver a virtual city browsing experience to a user of the computers 512A, 512N. In an embodiment, a particular city server 501A can host and deliver one or more virtual cities to clients such as browsers 504.

Universe server 500 comprises a computer system that hosts a database identifying all city servers 501A, 501B, 501N and that can interact with computers 512A, 512N to enable selection of a particular city server for a browsing session. Universe server 500 may be implemented as a process attached to a database. One or more processes in the universe server 500 enable a list of virtual cities to be available to all city servers 501A, 501B, 501N and browsers 504. Further, by managing the virtual city list, universe server 500 may selectively cut off access to particular virtual cities for a specified time period or permanently. Thus, universe server 500 acts as an authoritative directory for all city servers 501A, 501B, 501N. Universe server 500 also may manage and deliver template representations 528 for cities to enable users to create user cities, as described further below. In another embodiment, the template representations of cities are located on city servers rather than the universe server.

In one embodiment, universe server 500 communicates with city servers 501A, 501B, 501N using a secure streaming protocol. The streaming protocol provides a computer system and programming language neutral compact binary format to permit communication between the different components of the system. City servers 501A, 501B, 501N communicate with browser 504 using a data definition of a virtual city. In one embodiment, an XML stream or file represents a virtual city and is delivered on demand from city servers 501A, 501B, 501N to browser 504.

FIG. 5B is a block diagram illustrating further architectural elements of the system of FIG. 5A. As seen in FIG. 5B, a city server 502 comprises one or more front-end servers 502A, 502B, a content database 506, one or more services or applications 526, and one or more interfaces 524. City server 502 also hosts, is linked to, or can access an auction system 520, one or more copies of a three-dimensional virtual space browser 504, a data definition of a virtual world 528, an account database 521, and a payment system 522. Further, one or more content providers 508A, 508B are communicatively coupled to network 510.

In one embodiment, city server 502 hosts a master copy of browser 504 and can deliver copies to requesting clients upon demand. In an alternative embodiment, a third party hosts the master copy and delivers copies to clients upon demand or in response to instructions from the city server. Thus, the location in the system of a master copy of browser 504 is not critical, provided that client computers can access a copy in some manner upon demand. Clients that receive copies of the browser 504 install the browser and execute it in the client machine.

The one or more front-end servers 502A, 502B interact in a server-client relationship with computers 512A, 512B, 512C that are browsing or viewing a virtual city or virtual world that is offered by the city server 502. For example, front-end servers 502A, 502B are responsible for receiving requests from computers 512A, 512B, 512C and delivering copies of the data definition 528 to the requesting computers. Front-end servers 502A, 502B also may include a statistics module configured to request and receive statistical information or navigation information from browser 504 at any of the computers 512A, 512B, 512C. The statistics module is also configured for processing the statistical or navigation information, and providing aggregated or summary information to other elements of the city server 502. In an alternative embodiment the statistics processor is separate to the front-end servers 502A, 502B.

In one embodiment, front-end servers 502A, 502B communicate with other elements of a city server 502 using the secure streaming protocol identified above.

The data definition 528 describes a virtual world or virtual city as defined by an owner or operator of city server 502. In one embodiment, data definition 528 comprises one or more XML files that describe a virtual city. An example of an XML representation of a virtual city is provided herein in Appendix 1. In this example, the XML files provide functions as follows.

Content database 506 stores information about one or more content providers that provide information content for display at the computers 512A, 512B, 512C within display windows of a virtual city hosted by the city server 502. Content providers 508A, 508B may comprise any parties that may potentially display advertisements or information content in virtual display windows of a virtual city defined by the city server 502, such as Web sites, advertisers, or other online service providers, merchants, etc. Thus, the content database 506 indicates which content provider is currently responsible for delivering content when a particular computer 512C navigates to a particular window in the virtual city or virtual world. This would include the location of the content and the identity of the display window to which the content is cross-referenced.

The services or applications 526 comprise one or more computer programs or other software elements that implement services provided by the city server 502. Examples of services include enrolling content tenants, negotiating renewals of leases for virtual display windows with content tenants, administrative services relating to tenant accounts, administrative tools for defining a layout of the virtual city hosted by the city server 502, etc.

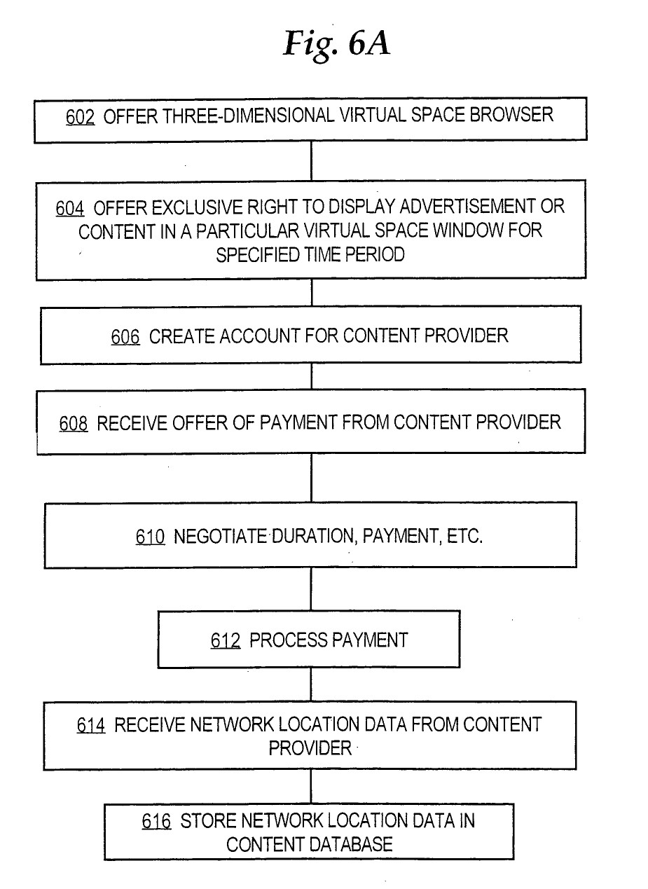

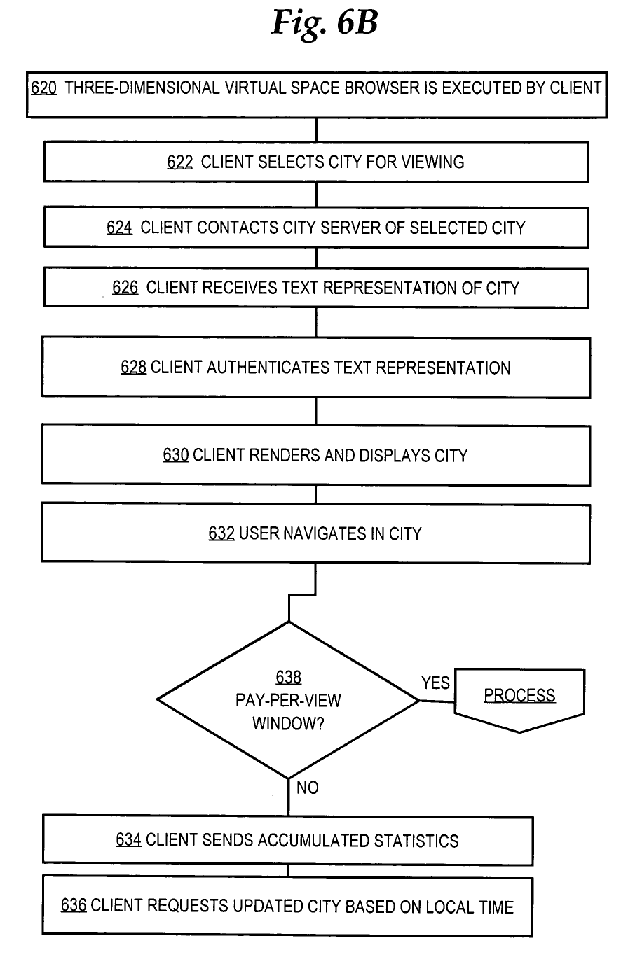

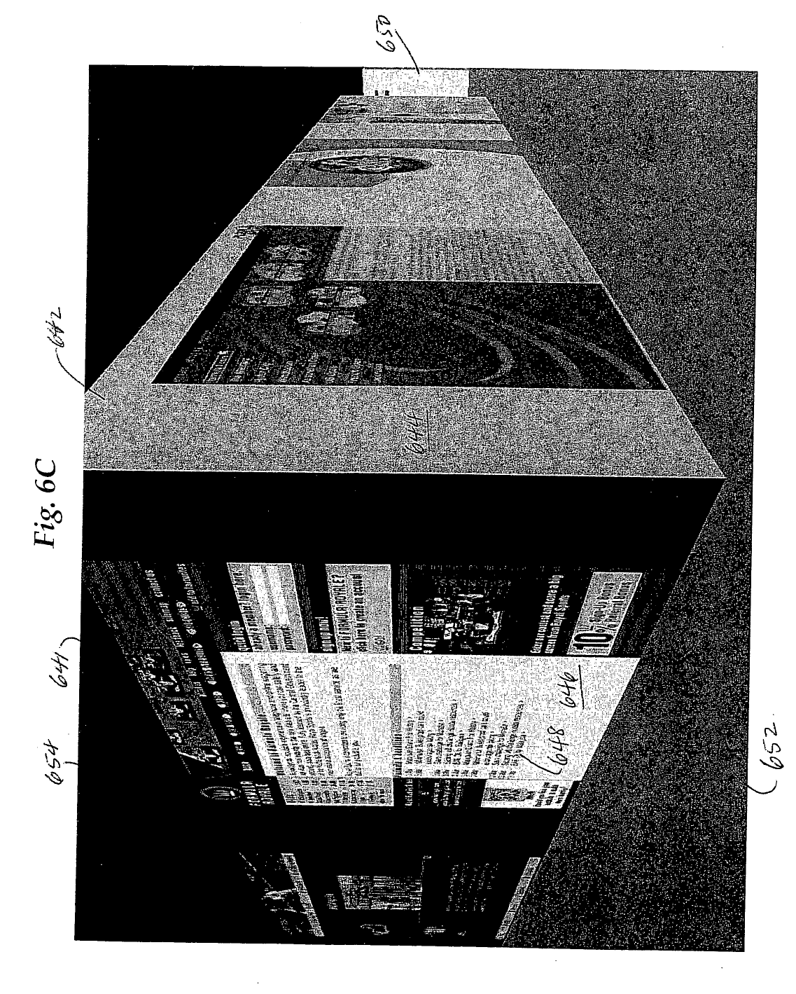

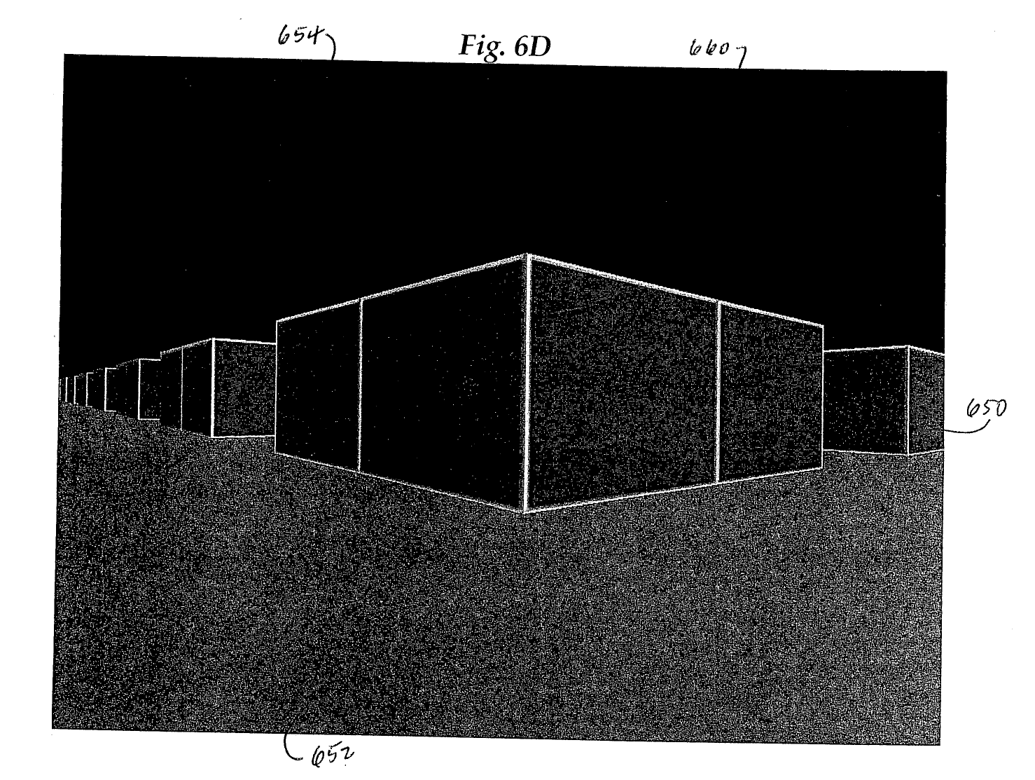

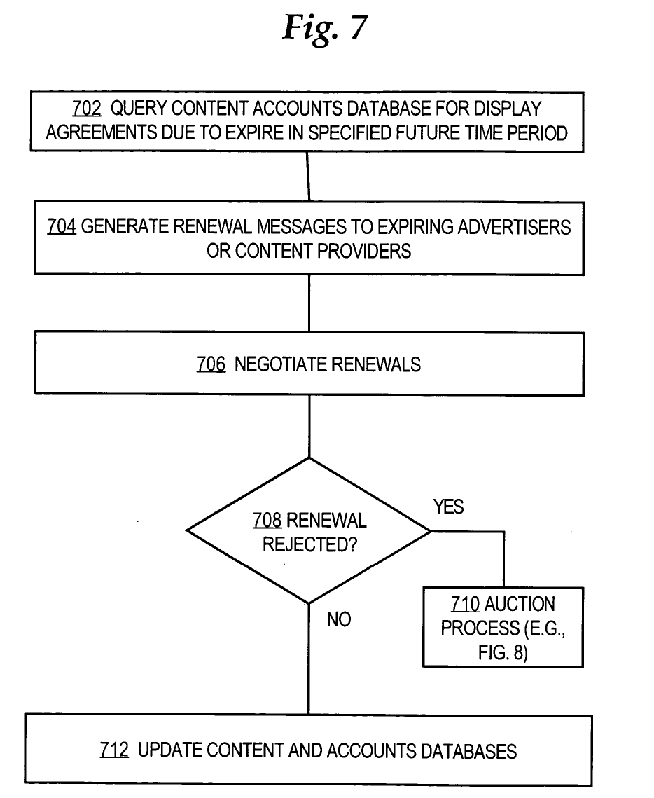

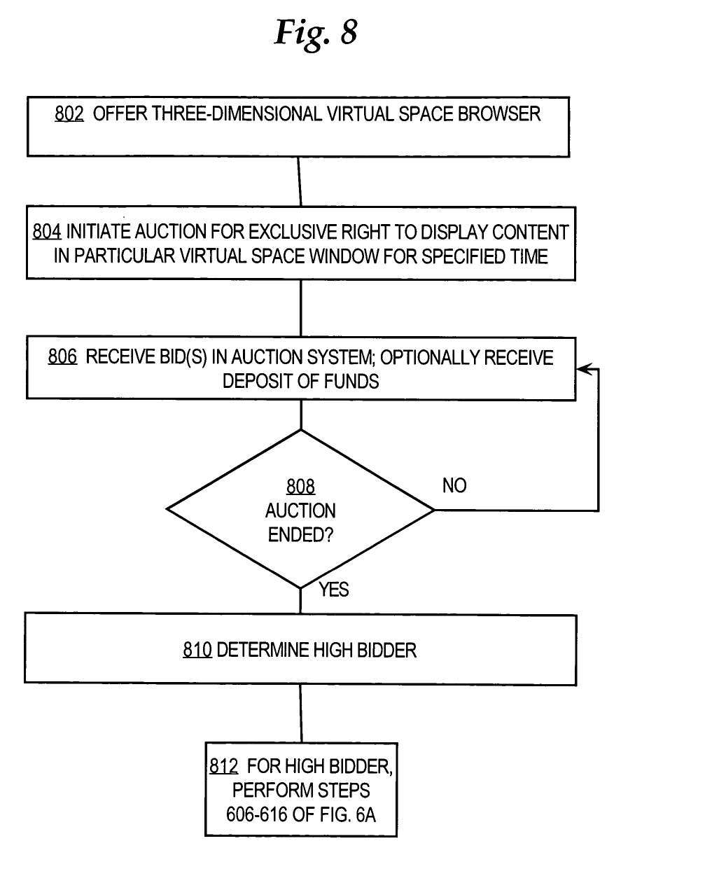

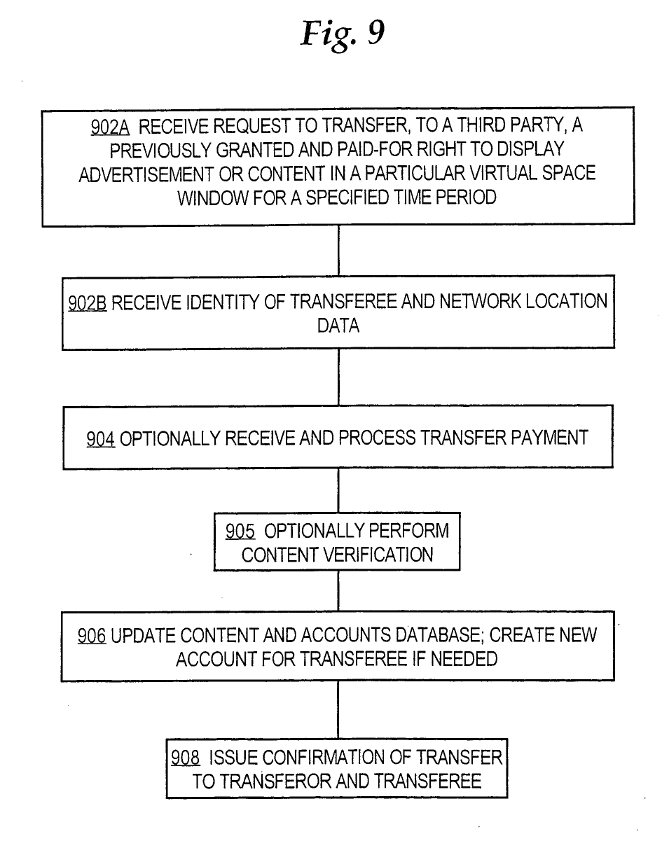

Interfaces 524 may comprise a graphical user interface or an electronic interface accessible to processes or machines, such as an application programming interface (API). For example, city server 502 may provide a GUI for administrative use, a Web GUI interface for use by tenants holding accounts associated with the virtual city, an API for updating content information, etc. In one embodiment, interfaces 524 provide methods for users or processes to access services and applications 526 for the purpose of performing the processes described herein with respect to FIG. 6A, FIG. 6B, FIG. 7, FIG. 8, FIG. 9.

Using auction system 520, city server 502 can auction rights to display content at one or more virtual display windows in the virtual city associated with the city server, according to processes described further herein. For example, to initially transfer display rights to a tenant, or to transfer display rights at the time that a tenant fails to renew a prior right, city server 502 can auction display rights to the highest bidder using an online auction system.

Account database 521 stores information about tenants of a virtual city and status of payment for virtual display rights. The account database may store account information, contact information, etc, about such content providers or tenants. Payment system 522 receives and processes payments for display rights.

In one embodiment, each city server 502 is owned or operated by a party in the business of offering virtual display windows for lease in exchange for consideration in the nature of rental fees. In an alternative embodiment, the ownership or operation of different aspects of the city server could be separated. The City Server could be represented by several computer servers. For example, all of the services relating to the City Server with the exception of the Front End Servers could be hosted by the same party that hosts the Universe Server. In this embodiment the one or more Front End Servers could be operated by the service provider that operates the city or cities.

In an alternative embodiment, a user city server is owned or operated by a service provider who allows end users to create their own virtual cities that are hosted and delivered by the service provider. Such a user city server also may be owned or operated by any other party. Such user cities may be restricted to being smaller than commercial virtual cities in terms of the number of virtual display windows. In this embodiment, the user city server delivers the user cities in the same manner as commercial virtual cities.

In another embodiment, the universe server or the user city server provides one or more baseline virtual city templates that may be used by users to develop particular virtual cities. A template representation of a user city may include one or more values not found in a normal virtual city. For example, a user city template representation may contain additional instructions that indicate how the city template can be extended. In this embodiment, user cities as represented by text in an XML file, could potentially be hosted on any web server, much like a web page, without any of the other functionality of the City Server. Such user cities would also not allow for any detailed statistical tracking of movements within the user cities.

Thus, either of the above embodiments allows end users to create user cities.

2.3 Establishing City Content; Browsing City Content

FIG. 6A is a flow diagram of a process of establishing a city server. In one embodiment, the process of FIG. 6A is implemented as part of services and applications 526 in a city server 502.

At step 602, a three-dimensional virtual space browser is offered. For example, at step 602, city server 502 hosts an HTML document that contains links for downloading copies of virtual space browser 504. At step 604, the exclusive right to display an advertisement or other content in a particular virtual space window for a specified time period is offered. For example, city server 502 may provide one or more HTML documents that specify display window locations in a virtual city and provide an offer to lease a display right for such locations for a specified fee or rent amount.

At step 606, an account is created for a content provider. Step 606 assumes that a content provider, such as an advertiser or an owner or operator of a Web site, has viewed the offers of step 604, selected a particular virtual space that the content provider wishes to lease, and indicated interest in leasing, for example, by selecting a link that notifies the city server 502 of such interest.

At step 608, an offer of payment is received from a content provider. For example, as part of providing a notification of interest in leasing a particular virtual space, content provider 508A may offer a particular fee or agree to pay a fee or rental amount or deposit that is advertised by the city server in connection with the selected space.

At step 610, the city server and content provider negotiate the duration of a virtual window display lease, payment amount, and other terms of a lease transaction as necessary. Step 610 may be performed through human interaction or through manual or automated exchange of electronic messages.

At step 612, a payment is processed. For example, city server 502 receives an HTML document representing payment information from the content provider 508A. After step 612, a city server virtual window lease transaction is complete.

At step 614, network location data is received from the content provider, and at step 616 the network location data is stored in a content database. In one embodiment, content provider 508A provides, to city server 502, a URL or other identifier for a Web page, image, file, or other information. In response, city server 502 stores the URL or other identifier in content database 506 in association with an identifier of the particular virtual window display location that has been leased by content provider 508A. Thereafter, the URL is delivered as part of data definition 528 when requested by computer 512C. As a result, when a user of computer 512C browses a virtual city represented by the data definition 528 using browser 504, the browser displays the content identified in the URL by content provider 508A when the user is viewing the virtual display window that has been leased by the content provider. Further, this approach offers the benefit that the city server 502 does not host content, which may require significant mass storage. Instead, the content is hosted by the content provider 508A and merely referenced in the data definition 528 and in databases of the city server 502.

In one embodiment, a content provider may make changes to the URL by interacting with interfaces 524. For example, interfaces 524 may include a tenant access interface with which a tenant may specify an account name and password. Upon verification of the password, the tenant gains access to account information including HTML documents that display the URL or other network location identifier. Other information might include the display name of the display window and any category that the window might belong to. The tenant can enter updates to such information and submit an alternate page to the city server.

Illustrating the foregoing process in more detail, FIG. 6B is a flow diagram of a process of browsing a virtual city. At step 620, a three-dimensional virtual space browser is executed by a client. For example, computer 512C executes browser 504. In step 622, a client selects a city for viewing. In one embodiment, computer 512C connects to universe server 500 and receives a list of virtual cities that are then-currently managed by the universe server. The list may be delivered in an HTML document, and all information exchanged as part of the process of FIG. 6B may comprise HTML documents or XML documents or a continuous streaming format. A user of computer 512C then selects a particular virtual city, for example, by selecting a hyperlink or a user interface widget.

In step 624, the client contacts the Front End Server associated with the city server of the selected city. For example, selecting a particular city may result in the universe server redirecting the browser of the computer 512C to a particular city server 502. In step 626, the client receives a data definition of a virtual city. For example, when browser 504 of computer 512C contacts the Front End Server associated with the city server 502, the browser requests and the Front End Server for that city delivers a copy of data definition 528.

At step 628, the client authenticates the data definition. For example, browser 504 uses cryptographic techniques to validate a digital signature of city server 502 that has been applied to data definition 528. Using such authentication, the browser 504 can verify that the data definition 528 is genuine. As a result, malicious parties cannot substitute unauthorized content in a virtual city or otherwise manipulate the appearance or content of a virtual city.

Assuming authentication is successful, at step 630, the client renders and displays the virtual city, and in step 632 the user navigates within the virtual city to view information content displayed in one or more virtual display windows. In one embodiment, the three-dimensional virtual space browser 504 executed at computer 512C renders and displays a view of a virtual city based on parsing and interpreting the data definition 528. Typically an initial view that is rendered and displayed by browser 504 depicts only particular virtual windows of virtual buildings of the virtual city, as seen, for example, in FIG. 1, FIG. 2, FIG. 3, and FIG. 6C.

FIG. 6C is a diagram of a virtual city screen display generated by one embodiment of an information display method. Screen display 641 comprises one or more virtual buildings 642, 650 that include one or more virtual display windows 644, 646. Virtual buildings 642, 650 are depicted in virtual three-dimensional form and are delineated by virtual streets 652 and virtual sky 654. From a particular user viewpoint a first virtual building 642 may appear to be in a foreground or near position whereas a second virtual building 650 may appear to be in a background or far position.

In one embodiment, virtual display windows 644, 646 display textures rendered from HTML documents of online Web sites. Thus, the content of a particular virtual display window 646 appears the same as a corresponding Web site associated with a content provider that is the then-current tenant for the virtual display window. Further, a user may interact with a virtual display window as if the window is a Web page. For example, a user can navigate to a particular virtual display window 646, view and select hyperlinks 648. In an alternative embodiment the interaction might be partial, so that clicking anywhere on a particular display window may result in a user navigating to another web page, no matter where the click was positioned within the window. In yet another embodiment, the result of the interaction may cause the target Web site to open in a conventional two-dimensional web browser which forms another “view” within the virtual space browser. The content within the virtual space itself does not change as a result of the interaction, but the user switches to an alternate two-dimensional view of the web page. In an embodiment, a virtual city as displayed by browser 504 is rendered based upon a specified virtual city grid arrangement that is defined in the data definition 528. FIG. 6D is a diagram of a virtual city grid screen display generated by one embodiment of an information display method. In FIG. 6D, screen display 660 comprises one or more virtual buildings 642, 650 that include one or more virtual display windows 644, 646. Virtual buildings 642 are depicted in virtual three-dimensional form and are delineated by virtual streets 652.

Thus, unlike prior approaches, in the approach herein the virtual environment displays information content in the virtual display windows of virtual buildings. In contrast, in prior approaches a virtual environment has provided merely decorative textures that serve as a background for a game or other use of the virtual environment. In the present approach the information of the windows has inherent utility.

In step 638, a test is performed to determine if the user has navigated to a pay-per-view window. Step 638 is performed optionally in an embodiment that provides for regions of a virtual city that are protected by virtual gates and can be navigated only if the user satisfies particular criteria. Such criteria may include, for example, payment of a fee, the user having particular attributes such as a particular age, gender, security credential, etc. If the user selects a gate that provides entrance to a gated area, browser 504 generates and displays a pop-up window that prompts the user to enter a UserId and Password. If the user does not have a password, then the user is required to register and obtain a password, and the registration may involve making a payment. If the UserId and Password are found in the system database, then the user is permitted to navigate into the gated area.

In one embodiment, a three-dimensional virtual space browser maintains an internal log of all actions performed by a particular user at a client computer. In this embodiment, at step 634 the client sends accumulated statistical information to the Front End Server associated with the city server. Step 634 may be performed periodically by pushing such information, or a copy of the browser log, to a city server 502. Alternatively, the browser 504 may implement an API that can be called by the city server 502 to request the log or statistical information on demand.

Such statistical information or activity log information may be used to support a market for transfers or transactions in virtual property consisting of the virtual display windows described herein. For example, statistical or activity log information indicates which virtual display windows are visited by a particular user. When such information is aggregated for all users, it indicates the amount of navigation traffic that is received for each virtual display window. A city server may use such traffic information to determine prices for tenant leases of the right to display content in a particular region, block, building or window. For example, a high volume of traffic at a particular virtual display window means that visitors to that display window are also likely to navigate to adjacent virtual display windows that are within the user's field of view. As a result, a high volume of traffic at a particular virtual display window means that adjacent windows also are more valuable.

Separately from the statistical log, the browser may keep a history of the locations visited and the virtual spaces visited by the user, so that the user may retrace some of the movements made in the browser. This retracing may optionally be executed in the form of a tour. The browser may also have one or more predefined tours for each virtual space which may be specified in the data definition, thereby allowing the user to quickly become familiar with the virtual space which they are viewing. Furthermore the user may decide to mark some of the virtual spaces and locations visited in MyPlaces which is a list of the user's preferred virtual spaces and locations.

In step 636, the client requests an updated city based on a local time value. In one embodiment, the data definition is periodically updated by the city server in response to changes in tenancy for virtual display windows, or to reflect the addition or deletion of windows or buildings from the virtual city. In this embodiment, the data definition is received by the client at repeated intervals that occur periodically during a browsing session. For example, browser 504 may implement a polling timer such that the browser requests an updated version of data definition 528 upon expiration of the polling timer. An example duration of the polling timer is 10 minutes, but any other appropriate interval may be used.

If the browser 504 is navigating a user city, special processing may be applied different from the processing described above that is used for commercial cities. For example, processing a user city typically will not involve collecting complete statistics at the browser and communicating them to the city server, as described herein with respect to step 634 of FIG. 6B. In processing a user city, rather than following the process of step 634, browser 504 may provide the city server only with a value indicating a number of requests for the user city data definition or XML. This value may simply be extracted from the log of connections made.

In an embodiment of user city processing, the data definition 528 may be hosted at any server. The data definition 528 may be unencrypted and not signed. Instead, browser 504 may verify the authenticity of the data definition 528 simply by recognizing a template identifier within the data definition.

In one variation of this approach, the universe server maintains a blacklist of user cities that contain offensive or otherwise unacceptable content, based on a URL of a host server that serves the data definition of the user city. In this approach, as part of step 622, 624, or 626, browser 504 determines whether a selected user city appears in a blacklist maintained by the universe server. If so, appropriate responsive action is taken, such as displaying a specified page that contains a warning message, displaying a warning message in a message field of the browser user interface, etc.

2.4 Renewals, Auctions and Transfers of Virtual Property

FIG. 7 is a flow diagram of a process of renewing a transaction associated with a display window in a virtual city. In one embodiment, the process of FIG. 7 is implemented in as part of applications or services 526 of a city server 502.

In step 702, a content accounts database is queried to identify one or more display agreements that are due to expire in a specified future time period. Step 702 may comprise performing a scheduled job that automatically queries a database, or may comprise manually issuing a query. As a result, a result set of one or more display agreement records is generated. The records relate to leases of virtual display windows in the virtual city managed by the associated city server.

In step 704, one or more renewal messages to expiring advertisers or content providers are generated. For example, based on the result set generated in step 702, automatic e-mail messages are generated and sent to content providers who are tenants or lessees identified in the result set records.

In step 706, renewals are negotiated. Step 706 may involve the city server and content provider negotiating the duration of a virtual window display lease, payment amount, and other terms of a lease transaction as necessary. Step 706 may be performed through human interaction or through manual or automated exchange of electronic messages.

Such a negotiation may or may not result in agreement among the parties to the terms of a renewal lease for a particular virtual display window. Accordingly, in step 708, a test is performed to determine whether a renewal has been rejected by a content provider acting as a tenant or lessee of a particular virtual display window. If so, then rights to the virtual display window may be auctioned, as indicated in step 710. For example, the auction process of FIG. 8 may be used. If renewal is successful, then in step 712 the content database and accounts databases are updated with information identifying a new lease term and other information relating to the renewed lease transaction.

FIG. 8 is a flow diagram of a process of auctioning a right to display information in a display window of a virtual city. In step 802, a three-dimensional virtual space browser may be offered and possibly an adapted data definition of the city which when rendered will provided information to potential bidders about virtual display windows on which they may place a bid. For example, as step 802, city server 502 hosts an HTML document that contains links for downloading copies of virtual space browser 504. In one embodiment, the process of FIG. 8 is implemented in as part of applications or services 526 of a city server 502.

At step 804, an auction is initiated for the exclusive right to display an advertisement or other content in a particular virtual display window for a specified time period. For example, city server 502 may provide one or more HTML documents that specify display window locations in a virtual city and provide an offer to auction a display right for such locations for a specified fee or rent amount. Alternatively, an external auction system 520 may be used to run auctions.

Such an online auction system may operate according to generally known principles in which a specified period of time is provided during which bidders may enter online bids for the offered rights. Bidders establish accounts with unique bidder identifier values, and enter into a binding agreement with the auction system 520 to complete a lease transaction for rights for which the bidders are successful. As shown in step 806, one or more bids are received in the auction system. The auction system optionally may require a deposit of funds as a surety or guaranty by which the bidder indicates a financial ability to complete a transaction.

At step 808, a test is performed to determine whether the auction has ended, and in step 810 a high bidder is determined. For example, upon expiration of the specified period of time, the auction system 520 automatically determines a winning bidder, notifies the winning bidder and an administrator of the city server 502, and provides instructions for completing a transaction. For example, as shown at step 812, the high bidder performs steps 606-616 of FIG. 6A to complete a transaction.

FIG. 9 is a flow diagram of a process of transferring a right to display information in a display window of a virtual city. In one embodiment, the process of FIG. 9 is implemented in as part of applications or services 526 of a city server 502. The process of FIG. 9 may be used as one part of a larger process of providing a market for virtual real estate in a virtual city managed by a city server.

In step 902A, a request is received to transfer, to a third party, a previously granted and paid-for right to display an advertisement or content in a particular virtual display window for a specified time period. For example, as step 902A, city server 502 hosts an HTML document that contains links for receiving an online form in which a tenant of a virtual display window may request the city server to transfer the tenant's window display rights to a third party. In step 902B, an identity of a transferee and network location data associated with the transferee are received. For example, the online form may include data entry fields or user interface widgets with which a tenant-transferor may specify a proposed transferee and a URL or other identifier of network content for future display in the tenant's particular virtual display window.

At step 904, a transfer payment is optionally received and processed. Thus, for example, city server 502 may optionally charge a fee for the service of transferring virtual display window rights from an existing tenant to a new tenant. If this option is implemented, then as part of step 904 the city server may require the transferor to provide a fee, which is processed using payment system 522.

In step 905, content verification is optionally performed. For example, city server 502 may accept only a particular kind of content for display by tenants in virtual display windows. Any standards may be applied by the city server at step 502. For example, one particular virtual city may restrict content only to information relating to a particular class of goods, a particular type of services, etc. Alternatively, step 905 may involve screening content of proposed transferees for acceptability to the users, etc. Step 905 may be performed through human interaction or via an automated process.

At step 906, content and accounts databases are updated, and a new account is created for a transferee if needed.

In step 908, a confirmation of the transfer is issued to the transferor and transferee. Step 908 may involve sending an automatic e-mail message, for example.

2.5 Three-Dimensional Virtual Space Browser Architecture

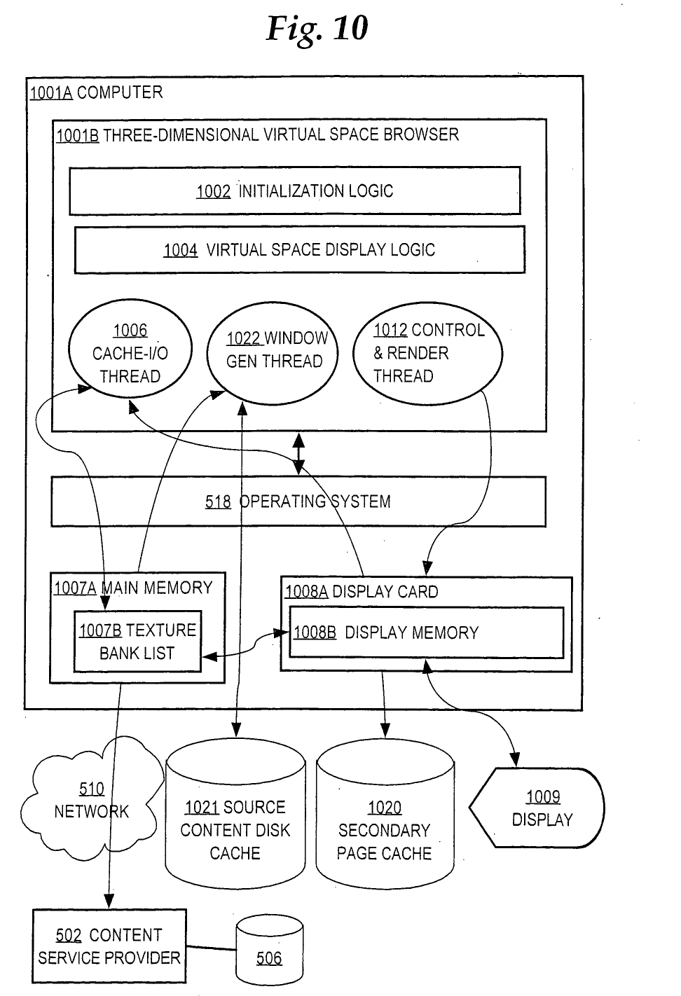

FIG. 10 is a block diagram of an example virtual space browsing system in which an embodiment may be used. A computer 1001A hosts a three-dimensional virtual space browser 1001B and an operating system 518. The computer 1001A also includes a main memory 1007A and a display card 1008A having display memory 1008B. Display card 1008A may be a separate card or integrated directly into computer 1001A. Display memory 1008B may be physically separate to main memory 1007A, or shared. Computer 1001A is communicatively coupled directly or indirectly through one or more networks 510 to a content service provider 502 that hosts stored content 506. In an embodiment, content service provider 502 comprises a city server of the type described in Gettman et al. Computer 1001A contains or can access a source content disk cache 1021 and secondary page cache 1020. Computer 1001A displays textures and other graphic images or subject matter on a display 1009. In one embodiment, computer 1001A comprises a personal computer based on the PCI bus, a workstation, a PDA, etc.

Three-dimensional virtual space browser 1001B comprises initialization logic 1002, virtual space display logic 1004, a cache-input/output (I/O) thread 1006, window generation thread 1022, and control/rendering thread 1012. Threads 1006, 1022, 1012 are spawned by virtual space display logic 1004 in cooperation with operating system 518 to perform the functions described herein.

In general, initialization logic 1002 interrogates display card 1008A, determines what graphic display functions are provided by the display card, and turns such functions on or off, including providing parameter values as needed. The foregoing capability of initialization logic 1002 is provided because various brands of graphics cards offer different types of display functions, thereby enabling three-dimensional virtual space browser 1001B to inter-operate with many different kinds of graphics cards. For example, display card 1008A may provide an anti-aliasing function for improving the appearance of graphical images that it displays. Initialization logic 1002 can detect the presence of an anti-aliasing function in display card 1008A and provide settings to enable the card to properly configure the function.

Further, in an embodiment, virtual space display logic 1004 interacts with display memory 1008B to display a relatively small number of high-resolution textures and a relatively large number of low-resolution textures. In this manner, display memory 1008B continuously stores high-resolution textures that are associated with virtual locations that are near a particular user viewpoint within a virtual three-dimensional space, which is a relatively small number of high-resolution textures, as well as all textures that appear in the distance with respect to the user viewpoint, which is a larger number of low-resolution textures. Techniques for maintaining the correct number of textures in display memory 1008B are described further herein.

In an embodiment, content 506 of a content service provider 502 comprises one or more HTML documents or Web pages. Computer 1001A can obtain an updated copy of content 506 at any time by communicating with content service provider 502 through network 510. Further, content 506 may be locally cached at computer 1001A using source content disk cache 1021. For example, source content disk cache 1021 can store all most recently used HTML documents or Web pages, or those documents or Web pages that are within a current field of view with respect to the user's then-current viewpoint of the virtual world, or that are likely to be viewed next by the user as indicated by the user's location within the virtual world.

Cache-I/O thread 1006 is responsible for loading content and paging content to the secondary page cache 1020. Window generation thread 1022 is responsible for retrieving content 506 from a content service provider 502 and generating a texture based on the content. The window generation thread 1022 is also responsible for saving updated content 506 to the source content disk cache 1021. Control & rendering thread 1012 is responsible for overall control of elements of the system and for rendering textures to the display card 1008A and its display memory 1008B in accordance with capabilities of the display card.

3.0 Hardware Overview

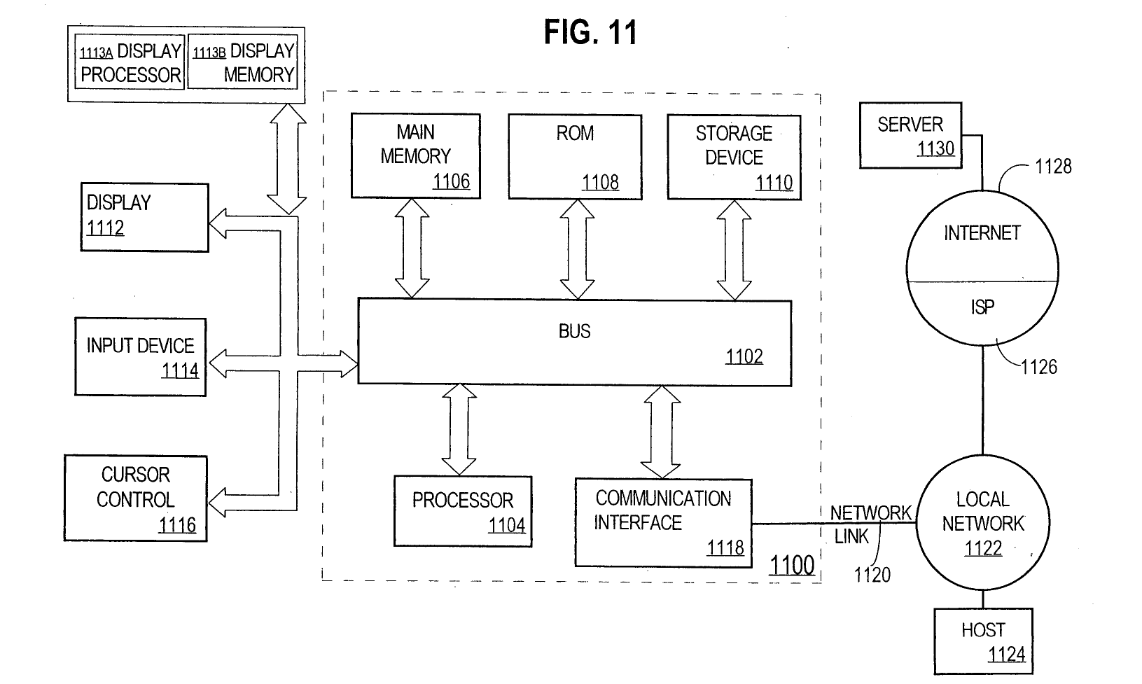

FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. Computer system 1100 may comprise a display processor 1113A and display memory 1113B coupled to bus 1102 for the purpose of storing image information and driving display 1112. For example, a display processor and display memory may be provided as part of a graphics card in the computer system 1100. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

The invention is related to the use of computer system 1100 for implementing the techniques described herein. According to one embodiment of the invention, those techniques are performed by computer system 1100 in response to processor 1104 executing one or more sequences of one or more instructions contained in main memory 1106. Such instructions may be read into main memory 1106 from another machine-readable medium, such as storage device 1110. Execution of the sequences of instructions contained in main memory 1106 causes processor 1104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 1100, various machine-readable media are involved, for example, in providing instructions to processor 1104 for execution. Such a medium may take many forms, including but not limited to, non-volatile media, volatile media, and transmission media. Non-volatile media includes, for example, optical or magnetic disks, such as storage device 1110. Volatile media includes dynamic memory, such as main memory 1106. Transmission media includes coaxial cables, copper wire and fiber optics, including the wires that comprise bus 1102. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1104 for execution. For example, the instructions may initially be carried on a magnetic disk of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are exemplary forms of carrier waves transporting the information.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution. In this manner, computer system 1100 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer system, comprising:
one or more content providing computers that are communicatively coupled to a network and that are associated with network location identifiers;
one or more city servers that are communicatively coupled to a network, wherein each of the city servers hosts one or more data definitions of virtual three-dimensional spaces, each comprising a plurality of virtual display windows, wherein each of the virtual display windows is allocated a specific position in the space and is associated with the network location identifier;
one or more client computers that are communicatively coupled to the network, wherein each of the client computers hosts a three-dimensional virtual space browser that is configured for receiving network content from the content providers based on the network location identifier and for displaying the virtual display windows along pre-defined channels within the virtual three-dimensional space, where many of the display windows are enabled for interaction.

2. A computer system according to claim 1, wherein the data definition includes the network location identifier in association with one or more position identifiers for a particular one of the plurality of virtual display windows.

3. A computer system according to claim 1, further comprising a universe server that is communicatively coupled to the network, wherein the universe server provides a list of the cities and associated city servers.

4. A computer system according to claim 1, wherein at least two of the virtual spaces are connected.

5. A computer system according to claim 1, wherein the browser is further configured to connect to the universe server, select one of the cities in the list, and connect to the associated city server.

6. A computer system according to claim 5, wherein the universe server is configured to digitally sign the list of cities, and the browser is further configured to authenticate the list of cities after reception from the universe server.

7. A computer system according to claim 1, wherein the content of the content provider comprises any one of HTML pages, XML pages, multimedia presentations, VRML, data, numbers, text, still images such as photographs or graphics, moving images, holograms, virtual control panels and sound files.

8. A computer system according to claim 1, wherein each virtual display window comprises one of a parallelogram, an ellipse, a scroll, a curved concave and/or convex surface, a polygon with straight and/or curved sides, a polyhedron with straight and/or curved edges, an elliptical solid, and an empty or amorphous space.

9. A computer system according to claim 1, wherein each of the one or more city servers comprises:
one or more front-end servers to which the clients connect;
a content database that stores information identifying the content provider and the network location identifier;
one or more services or applications; and
one or more interfaces to users or applications.

10. A computer system according to claim 1 wherein serving content is an additional function of the city server.

11. A computer system according to claim 9 or claim 10, wherein each of the components which comprise a city server may be distributed across one or more machines, and operated by one or more parties.

12. A computer system according to claim 1, wherein each of the one or more city servers further is configured for performing the steps of:
offering an exclusive right to display content in a particular virtual display window for a specified time period;
receiving, from the content provider, an offer of payment in consideration for the right;
negotiating terms of a virtual display window lease agreement;
receiving the network location identifier from the content provider; and
storing the network location identifier in a content database of the city server, wherein thereafter the browser displays content at the network location identifier of the content provider in response to a user navigating to the particular virtual display window.

13. A computer system according to claim 1, wherein the three-dimensional virtual space is a virtual city, wherein the three-dimensional virtual space browser further is configured for performing the steps of:
selecting a virtual city for viewing;
connecting to one of the city servers that is associated with the selected virtual city;
receiving the data definition of the virtual three-dimensional space; and
displaying the selected virtual city based on the data definition.

14. A computer system according to claim 13, further comprising the step of authenticating the data definition of the virtual three-dimensional space after receiving the data definition from the associated city server.

15. A computer system according to claim 13, further comprising the step of decrypting the encrypted data definition of the virtual three-dimensional space after receiving the data definition from the associated city server.

16. A computer system according to claim 13, further comprising creating and storing an activity log associated with movements of a user within the virtual city.

17. A computer system according to claim 16, wherein the activity log includes information identifying one or more virtual display windows actually rendered and displayed to the user.

18. A computer system according to claim 16, wherein the activity log includes information representing positions, movements and interactions executed by the user.

19. A computer system according to claim 16, wherein the activity log includes details for each virtual display window that is selected by a user.

20. A computer system according to claim 16, further comprising sending the activity log to the associated city server.

21. A computer system according to claim 16, wherein each of the city servers is further configured to determine a lease fee associated with a particular virtual display window based on an aggregation of the activity log received from users of the virtual city.

22. A computer system according to claim 13, wherein each of the city servers is further configured to determine a lease fee associated with a particular virtual display window based on an aggregation of data regarding interaction with display windows by users of the virtual city.

23. A computer system according to claim 22, wherein each of the city servers is further configured to perform the steps of:
creating and storing a list of one or more virtual display window lease agreements that expire within a specified time period;
generating and sending renewal messages to one or more content providers associated with the lease agreements in the list;
negotiating one or more renewals of the lease agreements in the list.

24. A computer system according to claim 22, further comprising the steps of, for any renewal negotiation that is unsuccessful, initiating an online auction of a right to display content in a particular virtual display window for a specified time period.

25. A computer system according to claim 1, further comprising an auction system that is communicatively coupled to one of the city servers, and wherein the auction system is configured for performing the steps of:
initiating an online auction of a right to display content in a particular virtual display window for a specified time period;
receiving one or more bids for the right;
determining which of the one or more bids is a highest or winning bid;
negotiating terms of a virtual display window lease agreement with a content provider who has issued the highest or winning bid.

26. A computer system according to claim 25, further comprising the step of requesting a deposit of funds from a bidder, wherein the funds comprise an amount sufficient to complete the virtual display window lease agreement if the bidder is the highest or winning bidder.

27. A computer system according to claim 1, wherein each of the city servers is further configured to perform the steps of:
receiving a request to transfer, to a transferee, a previously granted right to display content in a particular virtual display window for a specified time period;
receiving information identifying the transferee and a second network location identifier associated with the transferee; and
updating a content database of the city server with the second network location identifier.

28. A computer system according to claim 27, further comprising the step of receiving and processing a transfer payment.

29. A computer system according to claim 27, further comprising the step of verifying content associated with the second network location identifier.

30. A computer system according to claim 1, wherein the three-dimensional virtual space represents an actual town or city that exists or did exist in the physical world.

31. A computer system according to claim 1, wherein the three-dimensional virtual space represents a department store, and wherein the three-dimensional virtual space further comprises visual representations of aisles in the store, and wherein the virtual display windows comprise visual representations of shop floor displays in the store.

32. A computer system according to claim 1, wherein the three-dimensional virtual space is a visual representation of the inside of a supermarket, and wherein the three-dimensional virtual space further comprises visual representations of aisles in the supermarket, and wherein the virtual display windows are visual representations of shelves in the supermarket.

33. A computer system according to claim 1, wherein the three-dimensional virtual space is a visual representation of a shopping mall, and wherein the three-dimensional virtual space further comprises visual representations of walkways in the shopping mall and wherein the virtual display windows are visual representations of the shop-fronts in the mall.

34. A computer system according to claim 1, wherein the three-dimensional virtual space is a visual representation of a library interior, wherein the three-dimensional virtual space comprises visual representations of aisles in the library, and wherein the virtual display windows are visual representations of library shelves.

35. A computer system according to claim 1, wherein the three-dimensional virtual space contains at least one navigational reference object at a predetermined position.

36. A computer system according to claim 35, wherein the navigational reference object comprises any one of a gateway, landmark, ambient condition and advertisement.

37. A computer system according to claim 1, wherein a height of virtual three-dimensional structures in the three-dimensional space is varied to aid navigation.

38. A computer system according to claim 35, wherein the navigational reference object is an advertisement, wherein the advertisement is rendered similar to content of a display window and is specified by an actual commercial enterprise or other organization or entity in exchange for actual financial payments.

39. A computer system according to claim 1, wherein the network content comprises one or more sets of material content that are associated by one or more characteristics, and wherein the sets of material content are cross referenced to one or more virtual display windows that are spatially grouped together in the three-dimensional virtual space.

40. A computer system according to claim 1, wherein the network content that is rendered in a virtual display window at a particular position at a particular time is determined based upon one or more of the number, behavior and/or nature of viewers who navigate to or near that position in the three-dimensional virtual space; the nature of material content in other display windows near that position; the availability of material content for the display window at the selected position; or restrictions on the type of material content being cross referenced.

41. A computer system according to claim 1, wherein one or more of the city servers is configured to prevent a user of the one or more client computers from navigating into a restricted area of the virtual three-dimensional space unless the user fits a certain profile or fulfills certain conditions.

42. A computer system according to claim 1, wherein the virtual three-dimensional space is initially rendered with a virtual viewpoint positioned at one of a number of points of entry into the virtual three-dimensional space.

43. A computer system according to claim 42, wherein the point of entry is a destination of a user after leaving another three-dimensional virtual space.

44. A computer system according to claim 1, wherein the three-dimensional virtual space browser is further configured for providing a first system for rapid user movement through the three-dimensional virtual space from specified start and stop positions, so as to simulate travel via an underground railway, an over-ground railway, or an elevated railway or cable-car.

45. A computer system according to claim 1, wherein the three-dimensional virtual space browser is further configured for providing a second system for rapid user movement through the three-dimensional virtual space, wherein a user can determine locations for starting and stopping, so as to simulate travel via a taxi or helicopter.

46. A computer system according to any of claims 44 or 45, wherein the user can simulate movement through the three-dimensional virtual space only by the first or second system or by moving through the space at a normal pace through along channels and cannot transfer from one virtual position to another virtual position other than by the first or second system or by moving through the space at a normal pace along channels.

47. A computer system according to claim 1, wherein the browser is further configured for displaying the three-dimensional virtual space from an elevated perspective looking downwards at an angle from a simulated height or from a bird's-eye perspective looking directly downwards from a simulated height.

48. A computer system according to claim 1, wherein the browser is further configured for displaying a two-dimensional or three-dimensional topological map of the three-dimensional virtual space.

49. A computer system according to claim 48, wherein the topological map highlights any one or more of: one or more predetermined points of entry into or exit from the three dimensional virtual space; one or more fixed start and stop locations for rapid transport; and one or more navigational reference objects.

50. A computer system according to claim 1, wherein the browser is configured for performing the steps of:
receiving network content from the content provider based on the network location identifier; and
rendering and displaying the virtual display windows within the virtual three-dimensional space by:
dynamically selecting one or more of the virtual display windows;
rendering content associated with each of the selected one or more virtual display windows to memory; and
copying the rendered content into one or more designated virtual display windows.

51. A computer system according to claim 1, wherein the browser is configured to display a subset of the display windows at a high definition, and others at a lower definition, based on the user's viewpoint in the virtual space.

52. A computer system according to claim 51, wherein the browser is further configured for performing the steps of identifying a current position and navigation direction of a viewer and using said position and said direction for selecting the subset of display windows.

53. A computer system according to claim 51, wherein the browser is further configured for performing the steps of recording one or more movements and a speed of the viewer and using said movements and speed for selecting the subset of display windows.

54. A computer system according to claim 51, wherein the browser is configured for performing the steps of recording history data representing all or part of a history of viewer activities and using the history data for selecting the subset of display windows.

55. A computer system according to claim 51, wherein the browser is configured for performing the steps of recording timestamp data representing a last modification date and time of rendered network content and using the timestamp data for selecting the subset of display windows.

56. A computer system according to claim 51, wherein the browser is configured for performing the steps of suspending one or more updates of one or more display windows that are with animated or interactive network content and that are out of view or far from the viewer, but which are soon likely to be in view and near to the viewer.

57. A computer system according to claim 1 wherein the browser is configured for performing the steps of limiting or suspending computer resources allocated to rendering of a subset of virtual display windows to memory whenever the position of the viewer is changing.

58. A computer system according to claim 51, wherein the browser is configured for performing the steps of granting processing priority to virtual display windows that are associated with network content that is less computer-resource intensive, wherein granting processing priority comprises that such virtual display windows are more likely to be selected as part of the subset of display windows, are more likely to remain part of the subset, and are allocated more computer resources while part of the subset.

59. A computer system according to claim 1, wherein each of the city servers is configured to encrypt the data definition to protect the integrity of the data definition.

60. A computer system according to claim 59, wherein each of the city servers is configured to digitally sign the data definition using a private key associated with the two-part encryption key.

61. A computer system according to claim 3 or claim 60, wherein the universe server is further configured to provide the public key of each city server's two-part digital signature key and providing the public key to the one or more client computers, wherein receiving the public key enables the one or more client computers to verify the signature.

62. A computer system according to claim 1, wherein a statistics collection unit collects the statistical data from multiple browsers, and a statistics processor is configured for collating the statistical data from multiple viewers.

63. A computer system according to claim 62, wherein a graphical representation of the statistical data is generated.

64. A computer system according to claim 63, wherein the graphical format is a contour map.

65. A computer system according to claim 1, wherein each of the client computers further comprises a display, wherein the display comprises any one of a computer screen, a television screen, a screen of a game console, a personal digital assistant screen, a cell phone display, a projection, a pair of projection spectacles, a cerebral implant display, or a pair of virtual reality spectacles.

66. A computer system according to claim 1, wherein each of the client computers further comprises interaction means for a viewer to interact with the network content displayed in at least one of the virtual display windows.

67. A computer system according to claim 66, wherein the interaction means comprises at least one of a computer keyboard, a mouse, a joystick, a game pad, a games console controller, virtual reality gloves, a trackpad, a trackball, a cerebral implant, an eye movement detection device, a motion detection device, and a touchscreen.

68. A computer system according to claim 66, wherein the interaction with the network content displayed in a virtual window causes the same or predefined network content opening in a two-dimensional web browser.

69. A computer system according to claim 66, wherein the interaction with the network content displayed in a virtual window causes the network content which corresponds to the target of the hyperlink to open in a two-dimensional web browser.

70. A computer system according to claim 66, wherein the interaction with the network content displayed in a virtual window results in a change in the network content displayed in that virtual display window.

71. A computer system according to claim 1, wherein each of the client computers further comprises means for navigating the virtual three-dimensional space, wherein the navigation means comprises any one or more of a computer keyboard, a mouse, a joystick, a game pad, a games console controller, virtual reality gloves, a trackpad, a trackball, a cerebral implant, an eye movement detection device, a motion detection device, and a touchscreen.

72. A computer system according to claim 1, wherein the browser comprises one or more stored sequences of instructions which, when executed by one or more processors, cause the one or more processors to perform the steps of:
mapping a plurality of display windows within a virtual three-dimensional space so that each display window is allocated a specific and predetermined position in the space,
rendering each display window in three-dimensional perspective according to its position and angle relative to a viewer's virtual position in the virtual space,
cross-referencing the position of each display window to a network address or storage location of the material content that is designated to be rendered in that particular display window at a particular time based on at least one predetermined condition,
allocating at least part of the three-dimensional virtual space to display windows whose content is not chosen or determined by the viewer,
selecting, retrieving and preparing material content for possible subsequent display, according to a predetermined algorithm,
selecting and rendering prepared material content within its cross-referenced display window, according to a predetermined algorithm,
providing a means of virtual navigation that changes the viewer's position in the space in such a manner as to simulate movement through a plurality of predefined channels in the virtual space.

73. A computer system according to claim 72, wherein the browser further comprises instructions for preventing the viewer from editing the cross-references.

74. A computer system according to claim 72, wherein the browser further comprises instructions for preventing the viewer from altering the position of display windows in the virtual space.

75. A computer system according to claim 72, wherein the browser further comprises instructions arranged in a first part adapted to run at high priority to control display of the virtual three-dimensional space, and a second part, adapted to run at a lower priority, which controls updating of the material content in the virtual display windows.

76. A computer system according to claim 1 wherein the browser is configured to store a record of the virtual spaces which have been visited and in addition which the user has designated to mark, in order that the user may revisit these particular virtual spaces at a later date.

77. A computer system according to claim 76 or claim 3 wherein the list of marked virtual spaces may also include virtual spaces which are designated by the universe server.

78. A computer system according to claim 1 wherein the browser is configured to record a history of particular positions within virtual spaces as well as virtual spaces visited, so that the user may revisit these positions and virtual spaces at a later date.

79. A computer system according to claim 1 wherein the browser is configured to move the viewing position automatically along a route of predefined places within the virtual space, wherein the positions comprised in the tour are specified in the data definition provided by the city or by the universe server.
